(19) United States
(12) Patent Application Publication
(10) Pub. No.: US 2024/0347728 A1
(43) Pub. Date: Oct. 17, 2024

(54) ADVANCED ANODE MATERIALS COMPRISING SPHEROIDAL ADDITIVE-ENHANCED GRAPHITE PARTICLES AND PROCESS FOR MAKING SAME

(71) Applicants: FOCUS GRAPHITE INC., Kingston (CA); GRAFOID INC., Kingston (CA)

(72) Inventors: Joseph Eugene DONINGER, Lake Forest, IL (US); Michelle G. BARSUKOV, Glenview, IL (US); Igor V. BARSUKOV, Glenview, IL (US); Joseph Sathiya GNANARAJ, Wheeling, IL (US); Michaelangelo MONTERROSO, Prospect Heights, IL (US); Bruce Eckelberry WELLS, Aurora, IL (US)

(21) Appl. No.: 18/278,659

(22) PCT Filed: Feb. 24, 2022
(86) PCT No.: PCT/CA2022/050266

§ 371 Date: Aug. 24, 2023

Related U.S. Application Data
(60) Provisional application No. 63/153,156, filed on Feb. 24, 2021.

(51) Int. Cl. H01M 4/587; C01B 32/225; C01B 33/021; H01M 4/02; H01M 4/36; H01M 4/38; H01M 4/62; H01M 10/0525

(52) U.S. Cl. CPC H01M 4/587; C01B 32/225; C01B 33/021; H01M 4/364; H01M 4/366; H01M 4/386; H01M 4/62; H01M 10/0525; C01P 2004/03; C01P 2004/32; C01P 2004/80; C01P 2006/40; C01P 2006/80; H01M 2004/027

(57) ABSTRACT

The present invention provides a spheroidization method for the manufacture of additive-enhanced spheroidal graphite particles, and their application as lithium-ion battery anode active materials. Particles are comprised of natural crystalline flake graphite in combination with additive such as silicon nanoparticles or synthetic graphite. Preferably, graphite and additive particles are rolled into spheres using the spheroidization process of the present invention, followed by surface coating with a layer of amorphous carbon. In addition, a lithium ion battery is described, containing additive-enhanced graphite embedded into an agile matrix of high structure carbon black loaded at optimum compositions as a negative electrode.

### FIELD OF THE INVENTION

The present invention pertains to the field of electrode materials and in particular to processes for making materials for use in lithium-on batteries.

### BACKGROUND

Rechargeable lithium-ion batteries (LIB) are presently the commercialized electrochemical energy storage devices with the highest energy densities, measuring up to 250 Wh/kg. They are utilized especially in the sector of portable electronics, for power tools, laptop computers, means of transport, such as electric bicycles or Electric and Hybrid Electric automobiles, stationary energy storage plants and many other OEM products. Especially for application in automobiles, however, it is necessary to achieve further significant increase in the energy density of the batteries in order to obtain longer ranges for the electric vehicles.

Used in particular as negative electrode (“anode”) active material is graphitic carbon. Features of the graphitic carbon are its stable cycling properties and its decidedly high handling safety, in comparison to lithium metal which is used in lithium primary cells or in solid state batteries. Both natural and synthetic graphites may be employed, as well as combinations thereof. Where combinations of natural and synthetic graphites are used, the proportions of each component may be adjusted according to the specific performance goals of the end-use application.

A key argument in favor of the use of graphitic carbon in negative electrode materials lies in the small volume changes of the host material that are associated with the intercalation and deintercalation of lithium ions, i.e., the electrode remains approximately stable. For instance, for the intercalation of lithium ions in graphitic carbon, a volume increase of only up to 10 vol. % is measured for the limiting stoichiometry of LiC₆. A disadvantage, however, is its relatively low theoretical electrochemical reversible capacity of 372 mAh/g, which is only about one tenth of the electrochemical reversible capacity theoretically achievable with lithium metal.

Since silicon (Si) has an order of magnitude greater gravimetric capacity to store lithium (Li) compared to graphite, it has been pursued by battery manufacturers as an anode-grade active material for lithium-ion batteries (LIB). With pure silicon, theoretical reversible capacities of 4,200 mAh/g may be possible, which is well over ten times the capacity of graphite. However, the volume changes of Si during lithiation and de-lithiation in the cell were shown to be as large as 400 vol. %, as shown by Ruvinskiy et al. in “Nano-Silicon Containing Composite Graphitic Anodes with Improved Cycling Stability for Application in High Energy Lithium-Ion Batteries”, ECS J. Solid State Sci. Technol., 2 (10), M3028-M3033 (2013). Such changes could be detrimental to the mechanical integrity of the anode, leading to formation of excessive solid-electrolyte interphase (SEI) surrounding the particles, loss of electrical contacts, delamination of active layers from the current collector substrate, impeded Li⁺ mobility, and capacity fade. These factors exclude its stand-alone application in battery anodes. Vyacheslav Barsukov, in On Theoretical Prerequisites for Application of Novel Materials in Promising Energy Systems., NATO Science Series II: Mathematics, Physics and Chemistry (I.V. Barsukov et al. (eds.), New Carbon Based Materials for Electrochemical Energy Storage Systems: Batteries, Supercapacitors and Fuel Cells, Springer, V229, p 297-307 P. 317-331 (2006), formulated a principle that the only way for silicon to work would be to have it comprised of very small (nanosized) particles with very low loading levels preferably dispersed on a much larger-sized carbon carrier matrix. In this way, volumetric changes in individual particles of silicon would not cause any appreciable harm to the negative electrode on a macroscopic level.

Due to the limitations of using silicon alone in battery anodes, adding silicon to graphite to increase the theoretical capacity limit in lithium-ion batteries has been gaining intellectual traction.

US 2020/0044240 discloses micron or submicron particles (NPs) that are comprised of a variety of materials, including Group IVA elements, including silicon, that are known to have a high electrochemical capacity in Li-ion secondary batteries. The micron or sub-micron particles of the invention are provided with a surface layer, or surface modification, that imparts additional functionality to the particle. Surface modification prevents the formation of a dielectric oxide layer on the primary Group IV A particles, allowing elements of the surface modifier to covalently bond directly to the Group IV A elements, accommodates volumetric expansion to help mitigate ingress of electrolyte solvents from penetrating the surface modifier, mitigates disruption of SEI layers formed during electrochemical cycling, and provides favorable surface properties to allow the formation of strong bonding to binders and other materials in the electrode composite. It is said that the NPs can be combined with graphite particles by way of physical blending to create a composite graphite particle that can be used for battery anodes.

US 2016/0359162 discloses an electrode material for lithium-ion batteries, comprising 5-85% by weight of nanoscale silicon particles, which are not aggregated and of which the volume-weighted particle size distribution is between D₁₀>20 nm and D₉₀<2000 nm and has a breadth D₉₀-D₁₀<1200 nm; 0-40% by weight of an electrically conductive component containing nanoscale structures with dimensions of less than 800 μm; 0-80% by weight of graphite particles with a volume-weighted particle size distribution between D₁₀>0.2 μm and D₉₀<200 μm; 5-25% by weight of a binding agent; wherein a proportion of graphite particles and electrically conductive components produces in total at least 10% by weight.

U.S. Pat. No. 10,193,148 discloses a manufacturing method of a carbon-silicon composite including: (a) preparing a silicon-carbon-polymer matrix slurry including a silicon slurry, carbon particles, a monomer of polymer, and a cross-linking agent; (b) performing a heat treatment process on the matrix slurry to manufacture a silicon-carbon-polymer carbonized matrix; (c) pulverizing the carbonized matrix to manufacture a silicon-carbon-polymer carbonized matrix structure; and (d) mixing the carbonized matrix structure with a carbon raw material and performing a carbonization process to manufacture a carbon-silicon composite. The resulting carbon-silicon composite is used in the manufacture of an anode for a secondary battery.

U.S. Pat. No. 10,170,753 discloses a nano-silicon composite negative electrode material, including graphite matrix and nano-silicon material homogeneously deposited inside the graphite matrix, wherein the nano-silicon composite negative electrode material is prepared by using silicon source to chemical-vapor deposit nano-silicon particles inside hollowed graphite.

U.S. Pat. No. 10,629,895 discloses silicon/graphite/carbon composites (Si/G/C-composites), containing graphite (G) and non-aggregated, nanoscale silicon particles (Si), wherein the silicon particles are embedded in a carbon matrix (C). The invention also relates to a method for producing said type of composite, and the use of composite as electrode material for lithium-ion batteries.

It is worth noting that the vast majority of the aforementioned patents achieved stable cycling performance of silicon-rich anodes in basically impractical electrode assembles: indeed, silicon anodes can have stable cycling performance in electrodes with active material loadings of lower than or equal to 5 mg/cm². Despite their high specific capacity (which is typically measured in Wh/kg), these loadings are not considered attractive by the battery industry as their application leads to a greatly sacrificed volumetric energy density on a full cell level. The latter is measured in Wh per unit of cell volume, e.g. Wh/l. Practical active material loadings on the anode have to be on the order of 10 to 12 mg/cm² (or higher) for anode material to be considered battery-worthy.

There remains a need for a convenient and highly controllable process for the efficient incorporation of additives into a graphite matrix to provide generally spherical additive-enhanced graphite particles to provide materials suitable for use as advanced anode materials.

This background section is provided to reveal information believed by the applicant to be of possible relevance to the present invention. No admission is necessarily intended, nor should be construed, that any of the preceding information constitutes prior art against the present invention.

### SUMMARY OF THE INVENTION

An object of the present invention is to provide advanced anodic materials comprising spheroidal additive-enhanced graphite particles and a process for their manufacture. In accordance with an aspect of the present invention, there is provided process for preparing spheroidal additive-enhanced graphite particles comprising the steps of: providing a premixed composite of a flake graphitic component and one or more additive nanoparticles; and subjecting the premixed composite to a spheroidization process to provide the spheroidal additive-enhanced graphite particles. In one embodiment, the graphitic component comprises natural crystalline flake graphite. In one embodiment, the additive is a silicon nanoparticle. In one embodiment, the additive is synthetic graphite.

In accordance with another aspect of the present invention, there is provided spheroidal additive-enhanced graphite particles prepared using the process of the present invention.

In accordance with another aspect of the present invention, there is provided anode material comprising: from about 85 wt. % to about 90 wt. % of spheroidal additive-enhanced graphite particles of the present invention, from about 8 wt. % to about 12 wt. % of a binder component, and from about 0.5 wt. % to about 5 wt. % of an amorphous carbon component.

In accordance with another aspect of the present invention, there is provided a lithium-ion rechargeable battery comprising: an anode material in accordance with the present invention, an organic solvent electrolyte, a lithium-rich counter electrode, a separator, and a stainless steel cell housing in which the positive and the negative terminals are separated by a polymer spacer.

### BRIEF DESCRIPTION OF THE FIGURES

FIG. 1 illustrates a schematic cross-sectional view of a carbon coated additive-enhanced graphite particle, prepared in accordance with one embodiment of the present invention.

FIG. 2 is a schematic depiction of the process for preparing carbon coated additive-enhanced spheroidal graphite (SPG) particles, in accordance with one embodiment of the present invention.

FIGS. 3A-D are scanning electron micrographs of spheroidal graphite particles, with 0 wt. %, 9 wt. %, 13.5 wt. % and 18 wt. %, respectively, prepared using a spheroidization process in accordance with one embodiment of the present invention.

FIGS. 4 to 7 present a summary of electrochemical data obtained upon evaluation of a CR2016 coin cell prepared using a carbon coated silicon enhanced graphite particle comprising 9 wt. % silicon, prepared in accordance with one embodiment of the present invention.

FIGS. 8 to 11 present a summary of electrochemical data obtained upon evaluation of a coin cell prepared using a carbon coated silicon enhanced graphite particle comprising 9 wt. % silicon added after spheroidization of the graphite.

FIG. 12 shows a cutaway schematic cross-section of a CR2016 coin cell used in the testwork for assessing the electrochemical performance of additive-enhanced graphite particles.

FIG. 13 is a graphical depiction of the calculation of silicon content based on Loss on Ignition (LOI) data v. the initial batch addition quantity.

FIG. 14 is a graphical depiction of the galvanostatic charge-discharge curves for a CR2016 coin cell prepared using carbon coated SPG with the addition of 9 wt. % silicon after spheroidization.

FIG. 15 is a graphical depiction of the galvanostatic charge-discharge curves for a CR2016 coin cell prepared using carbon coated SPG with the addition of 4.5 wt. % silicon after spheroidization.

FIG. 16 is a graphical depiction of the galvanostatic charge-discharge curves for a CR2016 coin cell prepared using carbon coated SPG with the addition of 9 wt. % silicon prior to spheroidization, prepared in accordance with one embodiment of the present invention.

FIG. 17 is a graphical depiction of the galvanostatic charge-discharge curves for a CR2016 coin cell prepared using carbon coated SPG with the addition of 4.5 wt. % silicon prior to spheroidization, prepared in accordance with one embodiment of the present invention.

FIG. 18 is a graphical depiction of the effect of the amount of carbon black addition on the long-term cycling performance of CR2016 coin cells made with carbon coated silicon-enhanced SPG.

FIG. 19 is a graphical depiction of the galvanostatic charge-discharge curves for a CR2016 coin cell prepared using a physical blend of natural and synthetic graphite, ratio: 97.75/2.25 w/w %, both graphites being independently thermally purified, spheroidized (densified) and carbon coated prior to blending.

FIG. 20 is a graphical depiction of the galvanostatic charge-discharge curves for a CR2016 coin cell prepared using a co-processed composite of natural and synthetic graphite, ratio: 97.75/2.25 w/w %, respectively, the composite particle is carbon coated, prepared in accordance with one embodiment of the present invention.

FIG. 21 is a graphical depiction of the overlay of galvanostatic charge-discharge curves for a CR2016 coin cell prepared using spheroidized natural flake graphite with incorporated synthetic graphite, loaded at 2.25 wt. % and carbon coated, prepared in accordance with one embodiment of the present invention.

FIG. 22 is a graphical depiction of all cycle discharge/charge maximums for a CR2016 coin cell prepared using spheroidized natural flake graphite with incorporated synthetic graphite, loaded at 2.25 wt. % and carbon coated, prepared in accordance with one embodiment of the present invention.

FIG. 23 is a graphical depiction of the galvanostatic charge-discharge curves for a CR2016 coin cell prepared using a control anode active material, represented by densified thermally treated synthetic graphite grade SAM-1228, having particle size of Dsc=12 μm.

FIG. 24 is a graphical depiction of the galvanostatic charge-discharge curves for a CR2016 coin cell prepared using a control anode active material, represented by spheroidized, thermally purified carbon coated natural crystalline flake graphite grade Standard Grade CSPG, having particle size of D₅₀=23 μm.

FIG. 25 is a graphical depiction of all cycle discharge/charge maximums for a CR2016 coin cell prepared using spheroidized natural flake graphite with incorporated silicon, loaded at 2.25 (Series 1D), 4.5 (Series 1C), 9 (Series 1B) and 13 (Series 1A) wt. % respectively, and carbon coated, prepared in accordance with one embodiment of the present invention.

FIG. 26 is a graphical depiction of all cycle discharge/charge maximums for a CR2016 coin cell prepared using spheroidized natural flake graphite with incorporated silicon loaded at 9 wt. % (Series 2A), prepared in accordance with one embodiment of the present invention, and 9 wt. % as a physical blend (Series 2B), respectively, both carbon coated.

FIG. 27 is a graphical depiction of all cycle discharge/charge maximums for CR2016 coin cells prepared using spheroidized natural flake graphite with incorporated silicon loaded at 2.25 wt. % in-situ (Series 3A), prepared in accordance with one embodiment of the present invention, and 2.25 wt. % as a physical blend (Series 3B), respectively, both carbon coated.

FIG. 28 is a graphical depiction of the galvanostatic charge-discharge curves for a CR2016 coin cell prepared using a blend of natural and synthetic graphite, ratio: 75/25 w/w %, both graphites are thermally purified and carbon coated; natural graphite is additionally spheroidized prior to blending while synthetic graphite is densified.

FIG. 29 is a graphical depiction of the galvanostatic charge-discharge curves for a CR2016 coin cell prepared using a co-processed carbon coated composite particles comprising natural graphite and incorporated in-situ synthetic graphite, ratio: 75/25 w/w %, respectively, prepared in accordance with one embodiment of the present invention.

FIG. 30 is a graphical depiction of the charge/discharge cycles for a CR2016 coin cell prepared using the composite graphite particles composed of a blend of 25 wt. % synthetic graphite and the 75 wt. % of spheroidized natural graphite.

FIG. 31 is a graphical depiction of the charge/discharge cycling at C/20 rate for a CR2016 coin cell prepared using carbon coated composite graphite particles having co-processed purified natural graphite and incorporated purified synthetic graphite, taken at a ratio: 75/25 wt./wt. %, natural to synthetic, prepared in accordance with one embodiment of the present invention.

### DETAILED DESCRIPTION OF THE INVENTION

The present invention relates to a process for preparing spheroidal additive-enhanced graphite particulate materials that are principally suitable for use in a lithium-ion battery anode. The materials formed using these processes have enhanced performance characteristics relative to all-graphitic carbon anodes, and are also the subject of the present invention.

The process of the present invention provides a convenient and highly controllable way to tailor the performance of graphite-based anodes through the addition of varying amounts of additives, thus providing flexibility in adjusting the capacity of a lithium ion battery cell according to desired performance requirements.

The term “spheroidization” is used to describe a mechanical process for converting non-spherical and irregularly shaped particles into particles having a generally spherical, or spheroidal, shape.

As used herein, the terms “spheroidal” and “spheroidized” are used to describe the shape of a particle having a generally rounded, or generally spherical, shape, and the term “spheroid” is used to describe a generally rounded or generally spherical particle.

The term “physical blending” is used to describe the process of mixing or combining two or more components that results in a mixture of discrete particles of the components and does not involve any processes that cause physical transformation of the constituent component particles.

As used herein, the term “about” refers to a +/−10% variation from the nominal value. It is to be understood that such a variation is always included in a given value provided herein, whether or not it is specifically referred to.

Unless defined otherwise, all technical and scientific terms used herein have the same meaning as commonly understood by one of ordinary skill in the art to which this invention belongs.

In accordance with the present invention, the process for preparing spheroidal additive-enhanced graphite particles comprises the steps of providing a pre-blended composite mixture of one or more additives, and a high purity flake graphite, then subjecting the mixture to a spheroidization process to provide the spheroidized additive-enhanced graphite particles. In a preferred embodiment, the flake graphite is a high purity natural crystalline flake graphite component whose significant portion originates from a mined graphite mineral.

The formation of spheroidal particles is beneficial to provide maximized packing density in the construction of the lithium ion battery anodes, which will help with maximizing both the Specific Energy (measured in Wh/kg) and Energy Density (measured in Wh/L) on a full battery cell level. Therefore, spheroidization is an important prerequisite for building a successful battery-ready anode material.

In one embodiment, the process of preparing the spheroidal additive-enhanced graphite particles further comprises a step of applying an amorphous carbon coating on top of anode active material particle after the spheroidization step.

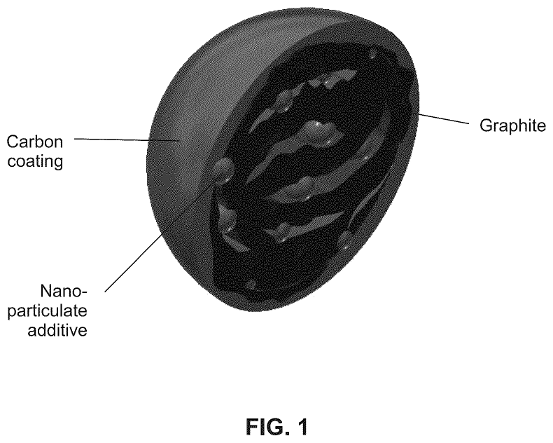

FIG. 1 provides a schematic cross-sectional view of a carbon coated additive-enhanced graphite particle, showing the flakes of graphite are folded on top of each other and around the additive particles to form a spheroidal additive-enhanced graphite particle.

In one embodiment, the one or more additives are selected from silicon, synthetic graphite, boron, germanium, tin, lead, aluminum, bismuth, magnesium, sulfur, and any combination thereof. In a preferred embodiment, the additive is a silicon nanoparticle. In another preferred embodiment, the additive is synthetic graphite.

In one embodiment, the graphite component undergoes one or more purification steps and/or a pre-sizing step prior to mixing with the additive particles. In one embodiment, the graphite component undergoes an expansion step.

In a preferred embodiment, the graphitic component comprises natural flake graphite. In a further preferred embodiment, the graphitic component comprises high purity natural flake graphite.

In one embodiment, a pre-sizing step for graphite component is carried out by air milling the graphitic material until the desired particle size has been reached. In the preferred embodiment this size is defined by laser diffraction and it falls in the range of 30<D₅₀<38 μm.

In one embodiment, the expansion step is carried out by intercalating a graphitic precursor with an acid and heating the intercalated graphitic precursor to provide an expanded graphitic component. Therefore, in one embodiment, the graphitic component optionally comprises an expanded graphite derived from a precursor natural crystalline flake graphite, a mined mineral that has gone through processes of primary beneficiation, such as wet ball milling, various forms of flotation, attrition, screening, etc.), which was followed by purification as stated below.

In one embodiment, the purification step is carried out by subjecting the graphite material to a thermal pre-treatment step (e.g., in a fluidized bed reactor or the like) and/or a chemical pre-treatment step (e.g., pre-treatment with an acid such as HNO₃, HF, HCl or the like).

Accordingly, in one embodiment of the present invention, the optimum sources of graphite include various forms of natural graphite, a mined mineral which has been processed using upstream processes (including, but not limited to, wet ball milling, various steps of flotation, attrition, sieving, etc.), and then additionally processed in a downstream processing (including. but not limited to, purification and sizing).

In one embodiment, the purity of the graphitic material prior to undergoing the spheroidization process is at least about 95 wt. % carbon based on a method of LOI 950 (that is Loss on Ignition conducted at 950° C.). In a preferred embodiment, the purity of the graphitic material is at least 99 wt. % carbon. In a preferred embodiment, the graphitic component is a high purity graphitic material comprising from about 99.5 wt. % to about 99.95 wt. % carbon. In a further preferred embodiment, the purity of the graphitic material is about 99.95 wt. % carbon, as determined by the method of loss on ignition. The latter method is described in detail by Fedorov et al. in “Ultrahigh-Temperature Continuous Reactors Based on Electrothermal Fluidized Bed Concept”. J. Fluids Eng. 2015; 138 (4): 044502-1-044502-11.

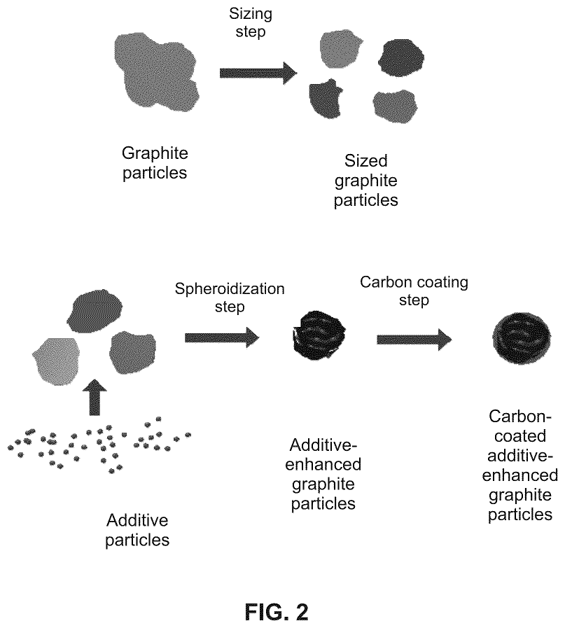

In accordance with a preferred embodiment of the present invention, high purity natural flake graphite undergoes mechanical spheroidization in the presence of additive nanoparticles, resulting in the incorporation of the additive nanoparticles within the consolidated flakes of graphite to form spheroidal additive-enhanced graphite particles. Use of a pre-blended mixture of additive nanoparticles and flake graphite assures that the additive is evenly distributed between the “onion skin-like” layers of graphite in each spheroidal particle. FIG. 2 is a schematic depiction of the process for preparing additive-enhanced spheroidal graphite (SPG) particles, including an optional carbon coating step, in accordance with one embodiment of the present invention.

In accordance with the present invention, the spheroidization process may be carried out using any milling process that results in the incorporation of the additive nanoparticles into the graphite matrix. This can be achieved, for example, through the pulverization of a mixture of the constituent components in a spheroidizing mill, a roller mill, a hammer mill, a pulverizing mill, or a hybridizer mill. In one embodiment, the spheroidization process may be carried out in a spheroidizing mill, or any mill that subjects the pre-blended particle mixture to repeated impacts with hammers or blades in a milling chamber. The repeated impacts lead to mechanical deformations in the particles while ensuring the complete mixing of the constituent components. As the particles in the mixture undergo repeated impacts and deformation, the graphitic and additive components become melded into a additive-graphite composite material, wherein the additive is distributed within a graphite matrix. Repeated impacts further lead to the spheroidization of the resulting composite material particles. The longer the material is subjected to the milling process, the more spheroidal the resultant particles become.

In one embodiment, the process should have a minimum frequency of 45 Hz and not exceeding 50 Hz for optimum “snowballing” effect.

As this process is repeated thousands of times per minute, the system is kept thermally controlled, for example, via a jacketed water cooling sub-system, to minimize any potential accelerated oxidation of the additive nanoparticles that may occur prior to the graphitic envelopment.

The indirect measure of sphericity used in the aforementioned embodiment is a value of Tap Density. Tap density of the powdered carbon material which is referred to herein was assessed with the Autotap machine by Quantachrome Instruments, Boynton Beach, FL (now owned by Anton Paar). The test is run in accordance with ASTM standards: D4781 “Standard Test Method for Mechanically Tapped Packing Density of Fine Catalyst Particles and Catalyst Carrier Particles”, D4164 “Standard Test Method for Mechanically Tapped Packing Density of Formed Catalyst and Catalyst Carriers”, and B 527-93 (2000) e1 “Standard Test Method for Determination of Tap Density of Metallic Powders and Compounds.” The Autotap machine furnishes an automated lifting (to a height of ⅛″), radial rotation by a quarter of a turn and dropping of the test container (a graduated glass cylinder of 250 mL volume). The Tap density was determined at 1,500 taps, which are accomplished within approximately 4 minutes. The sample being analyzed is gently poured into the graduated cylinder; in an unrestricted free flow it fills the 110 ml mark. The Tap Density of material in a preferred embodiment is greater than 0.9 g/cm³.

In one embodiment, the mechanical spheroidization process is carried out in a spheroidizing mill having a hollow main milling chamber having a rotor with a plurality of peripheral hammers or blades which are trapezoidal in shape and which are directed inwards towards the rotational center. Such a mill is described in U.S. Pat. No. 4,810,600, the disclosure of which is incorporated herein by reference. In a preferred embodiment, the hammers of the aforementioned milling system have an acute angle near the middle of the rotor and a right angle at the circumference. The pre-blended mixture of graphite and additive nanoparticles is introduced to the milling chamber through a funnel located at the top of the mill. An air-activated knocker opens a pneumatically actuated valve and allows mixture to fall into the main chamber. The airflow facilitates further release of mixture into the milling chamber.

The falling particulate mixture is hit by the hammers, causing the mechanical deformation and processing of the particles, forcing the particles towards the center. In the center of the rotor is a nose cone with a grooved channel, which captures the fine powdered material and moves the captured particles towards the tip of the nose cone, leading to aggregation of the captured particles. Once the captured material passes the tip, it is drawn into a recirculation tube, to be returned to the milling chamber for further processing followed by passing through the nose cone again. This is repeated thousands of times per minute, causing the particles in the particulate mixture to “snowball” and form an additive-graphite composite material in the shape of spheroids. Since finer particles make it to the center of the rotor faster, the smaller “guest” additive particles become trapped in the “host” graphite matrix.

After a given mill runtime, a discharge port opens. Spheroidal additive-enhanced graphite particles are discharged into a baghouse outfitted with a filter bag rated to trap particles of size one μm or greater. From the baghouse, the particles fall into a collection chamber, and are collected for analysis. The process can be run as a semi-continuous process, under automated control to allow a processing period for an optimized particle dwell time inside the mill prior to collection of the final product and introduction of the next batch of pre-mixed natural flake graphite and additive nanoparticle starting material. In one embodiment, the particle dwell time should be no less than about 30 minutes. In one embodiment, the particle dwell time should not exceed about 1 hr.

In one embodiment, the additive comprises silicon nanoparticles. In a preferred embodiment, the silicon component is a nanosized particle, whose size distribution most preferably ranges from 20 nm to 100 nm, but may fall in the broader range of 5 to 300 nm.

In another preferred embodiment the silicon component is originated from plasma pyrolysis of solid silicon dust to ultimately form monocrystalline silicon with as little as possible degree of SiO₂ passivating layer. In a preferred embodiment silicon nanoparticle has less than 10 vol. % of SiO₂ on its surface. Optionally, the silicon component could be an amorphous silicon derived from decomposition of silane gas (SiH₄).

Accordingly, in one embodiment of the present invention, an accurate assessment of the amount of silicon in the battery-ready spheroidal silicon-enhanced graphite particles is conducted using the model built on the results of a method of loss on ignition (knowing the exact loading of silicon is essential for balancing of an electrochemical device for its long-term cycling and gauging the value of reversible capacity).

In one embodiment, the silicon particles are amorphous silicon particles produced by vapor decomposition of silane gas (SiH₄), by plasma pyrolysis of silicon dust, by reduction of silicon carbide, by grinding or processing of waste silicon wafers, or by any other suitable method as is known in the art.

In one embodiment, the amorphous silicon used was produced by vapor deposition of silane gas at temperatures of <700° C. to form aggregated silicon nanoparticles and has an average primary particle size of about 100 nm. Due to the nature of the reaction, the resultant silicon may have a notable degree of passivation with SiO₂ (approximately 30 wt. %) which can reduce the effectiveness of silicon-enhanced graphite anode.

In one embodiment, the preferred type of silicon is produced by plasma pyrolysis of silicon dust at temperatures of 6,000 to 8,000 K, followed by quick quenching, to form monocrystalline Si which has less than 10 wt. % of passivating SiO₂ layer on the surface.

Accordingly, in one embodiment of the present invention, the optimum sources of silicon are defined for the spheroidal silicon-enhanced graphite particles. These include monocrystalline silicon and/or amorphous silicon. The aforementioned materials are defined as nanosized, having particle size of less than 300 nm but greater than 5 nm, and more preferably, 20 to 100 nm. Furthermore, in accordance with the present invention, the particles of nanoscale silicon are essentially surface oxide-free: specifically, an average silicon particle is typically covered by no greater than 10 to 30 wt. % of surface oxide (a substance known as SiO₂), while the oxide-coated particle of silicon is defined as SiOₓ due to the mixed overall stoichiometry.

In one embodiment, the pre-blended composite mixture further comprises elemental boron.

In accordance with a preferred embodiment of the present invention, pre-sized high purity natural crystalline flake graphite is blended with nanosized silicon in an inert gas (e.g. argon) atmosphere prior to spheroidization.

In one embodiment, the final silicon-enhanced graphite particles have D₅₀ in the range of about 10 μm to about 15 μm. In one embodiment, the final silicon-enhanced graphite particles have D₅₀ of about 12 μm. In one embodiment, the final silicon-enhanced graphite particles have D₅₀ in the range of about 16 μm to about 21 μm. In another embodiment, the final silicon-enhanced graphite particles have D₅₀ of about 17 μm. In one embodiment, the final silicon-enhanced graphite particles have D₅₀ in the range of about 22 μm to about 28 μm. In yet another embodiment, the final silicon-enhanced graphite particles have D₅₀ of about 25 μm.

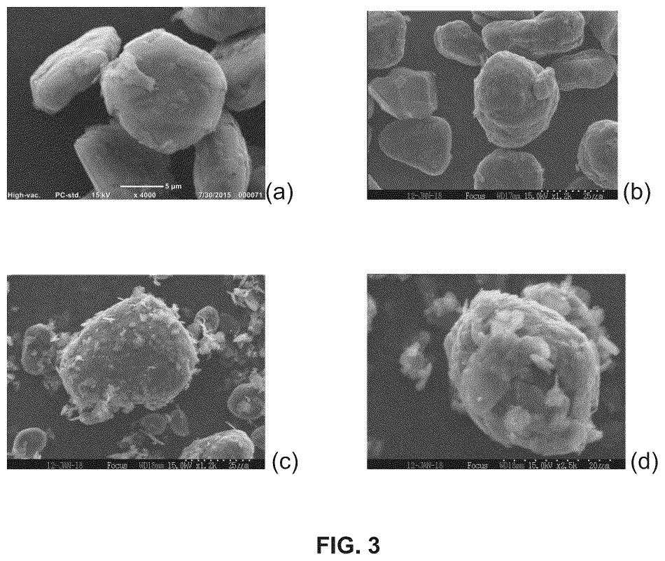

FIGS. 3B-D are SEM images of spheroidal graphite particles with varying amounts of silicon incorporated using the processes of the present invention, showing that the flakes of graphite are clearly folded on top of each other to form a spheroidal graphite particle. A scanning electron microscopy (SEM) image of spheroidal graphite with no incorporated silicon is shown in FIG. 3A. As the wt. % of silicon addition increases, more silicon particles appear on the surface of the spheroidal graphite particle, however, the spheroidal shape of the core graphite particle is retained across a range of silicon levels.

In a preferred embodiment, the anodes comprised of silicon-enhanced spheroidal graphite have active material loadings falling in the range from 6.24 mg/cm² to 16.20 mg/cm².

In accordance with one embodiment of the present invention, the spheroidal Si-graphite particle is further coated with an ultra-thin layer of amorphous carbon after the spheroidization step. It is believed that the carbon coating results in a reduction of the BET specific surface area of the spheroidal graphite relative to the uncoated particles and protects the silicon from forming silicon carbide and silica (SiO₂) at the surface.

In the carbon-coated embodiment, the exterior carbon shell should be as thin as possible to maintain permeability for the ingress and egress of lithium ions (Li⁺) into the graphitic core. The carbon coating serves three functions: it prevents the start of a thermal runaway by reducing the BET surface area of graphite; it reduces the irreversible capacity loss on the anode; and it functions as a cushioning substrate onto which the deposition of polymer binder will subsequently occur for formation of the anode.

In another preferred embodiment, the additive is synthetic graphite. A synthetic graphite-enhanced spheroidized graphite particle exhibited a significant improvement of performance as compared to natural graphite on its own or synthetic graphite on its own. Specifically, values of reversible capacity for the best synthetic graphite reach 340-355 mA*h/g. While natural graphite offers a higher capacity, in the case of the spheroidized natural graphite precursor, reversible capacity values were in the range of 350-360 mA*h/g. When a physical blend of the two graphites was made (by simple mixing), the reversible capacity value was measured at around 357 mA*h/g, which is to be expected by linear interpolation. However, when the synthetic graphite was rolled inside of the sphere of natural graphite using the spheroidization process of the present invention, a dramatic rise in reversible capacity was observed. The reversible capacity value for the spheroidized synthetic graphite-enhanced graphite particle was measured at 368-369 mA*h/g, and it remained a highly stable value through several dozen cycles in use of the anode of a lithium-ion battery. This signals a synergistic effect observed from combining the two types of graphite to form an anode-active material for lithium ion batteries.

There are several other advantages of putting synthetic graphite inside the natural graphite sphere. Firstly, synthetic graphite cannot be effectively spheroidized. At the same time, in building electrode assemblies, spherical or spheroidal shapes are preferred over any other geometries due to their maximized packing densities. As determined by Gauss in the late 19th century, spheres pack best of all shapes, naturally forming a packing scenario wherein approximately 74% of space is occupied, with the remainder being voids. The worst packing is exhibited by flaky or needle-like particles, which applies to synthetic graphite. In the worst-case scenario, needles packed can occupy as low as 30% of fillable material, leaving 70% as voids. Therefore, by taking a non-spherical synthetic graphite particle and rolling it inside of a natural graphite sphere to form the core of the sphere, the processes of the present invention have provided a means for overcoming a major packing issue with synthetic graphite.

Further, particles of synthetic graphite tend to have increased surface area as opposed to those of natural graphite. Surface area is linked to increased irreversible capacity loss and compromised safety of lithium-ion batteries. The lower the surface area, the higher the safety and the lower the irreversible capacity loss. In the case of composites formed by placing synthetic graphite particles inside a natural graphite sphere, the authors successfully created stable particle architectures whose irreversible capacity loss was less than 7%. The aforementioned number is characteristic of premium-quality anode-grade graphites on the lithium-ion market today.

Another benefit of combining natural and synthetic graphite pertains to the malleability of natural graphite. In battery anode designs, the goal is to maximize electrode density, which is accomplished by running freshly pasted dry electrode film through a set of calendaring rolls. Due to natural graphite's malleability, high densities in excess of 1.6 g/cm³ are impossible in the material. Passing through the rolls destroys spheres and turns the electrode into a nonporous, “hockey puck-like” film. At the same time, synthetic graphite has a high resiliency. For reference, resiliency is a measure of elastic deformation of material subjected to a compressive load. The resiliency of synthetic graphite allows for the entire particle to spring back to its original shape even at high densities of 1.6-1.8 g/cm³. In experiments with applying high pressure in the calendaring mill, no signs of composite particle degradation were observed.

We claim a composite particle formed by simultaneous spheroidization milling of sized natural and synthetic graphite particles, wherein both particles are initially nonspherical and meet certain particle size requirements such as D₅₀ ranging from 25 to 35 μm and D₅₀ less than 270 mesh. Both particles are co-processed inside a spheroidization mill operating on the mechanochemical principle described in previous claims. Processing is accomplished in such a manner that creates a unique particle architecture where synthetic graphite sits inside the spheroidal particle while natural graphite, being more malleable than its synthetic counterpart, wraps around the synthetic graphite core. The composite is further carbon-coated with a rigid shell based on the application of a soft carbon such as petroleum pitch.

In one embodiment of the present invention, a composite anode material is produced by incorporation of Group IVA elements of the Periodic table as a core into the spheroidal particle, whose outer shell is natural graphite. Group IVA, besides carbon, a nonmetal and silicon, a semi-metal, also includes germanium (a semi-metal), tin and lead (both metallic). In addition, boron, aluminum, bismuth, magnesium and the like can be incorporated inside the graphite structure to form viable anode materials for use in lithium-ion batteries. Publications by inventors of this patent which refer to composites of boron with graphite [1] and tin with graphite [2] can be found in the following references, the disclosures of which are incorporated herein by reference in their entirety:
[1] Joseph E Doninger. Cycling characteristics of Silicon Enhanced and Boronated Lac Knife Natural Flake Graphite from Quebec, Canada in Lithium Ion Batteries. Proc. of 36th International Battery Seminar and Exhibit, Fort Lauderdale, FL—Mar. 25 to 28, 2019.
[2] I.V. Barsukov et al (eds.), New Carbon Based Materials for Electrochemical Energy Storage Systems: Batteries, Supercapacitors and Fuel Cells. Springer (2006).

In accordance with one embodiment of the present invention, there is provided an anode material comprising: from about 85 wt. % to about 90 wt. % of spheroidal additive-enhanced graphite particles, from about 8 wt. % to about 12 wt. % of a binder component, and optionally from about 0.5 wt. % to about 5 wt. % of amorphous carbon component.

In an exemplary embodiment, the anode material comprises about 87 wt. % of the graphitic component, about 9.5 wt. % of the binder component, and about 3.5 wt. % of the amorphous carbon component. In one embodiment, the amorphous carbon component is high structure acetylene-type carbon black.

In accordance with one embodiment of the present invention, there is provided a lithium ion battery cell comprising: an anode material in accordance with the present invention, an electrolyte, a lithium-rich counter electrode, a separator, and a stainless steel cell housing in which the positive and the negative terminals are separated by a polymer spacer.

In one embodiment, adhesion of silicon-enhanced graphite to copper foil current collector is enabled by a polyvinylidene fluoride (PVDF) polymer.

In one embodiment, the electrolyte is an organic solvent electrolyte. In one embodiment, the electrolyte comprises lithium hexafluorophosphate. In one embodiment, the electrolyte is lithium hexafluorophosphate in ethylene carbonate/dimethyl carbonate (1:1).

In a preferred embodiment, the anode material comprises silicon enhanced spheroidal graphite particles prepared by a spheroidization process in accordance with the present invention.

In a preferred embodiment, the anode material comprises synthetic graphite-enhanced spheroidal graphite particles prepared by a spheroidization process in accordance with the present invention.

The invention will now be described with reference to specific examples. It will be understood that the following examples are intended to describe embodiments of the invention and are not intended to limit the invention in any way.

### Examples

### Example 1A: Preparation of Expanded Graphite

The expanded flake graphite materials that can be employed in the preparation of the silicon enhanced particles are prepared by intercalating a natural flake graphite precursor with an acid mixture (H₂SO₄ and HNO₃) and heating the intercalated graphite to about 850-950° C. in air to provide an expanded flake graphite.

### Example 1B: Purification of Graphite

The purified flake graphite materials employed in the preparation of the additive-enhanced particles are prepared by heating a natural flake graphite to about 2500° C. in a fluidized bed reactor.

### Example 2: Preparation of Silicon Enhanced Spheroidal Graphite Particles

### Method A-Si-Graphite Particles (Uncoated)

Purified flake graphite was air milled and screened to a maximum particle size of 270 mesh and mixed with nano sized silicon in a glove box in an atmosphere of argon gas. Silicon nanoparticles produced by plasma pyrolysis of silicon dust at 6000 to 8000K in a continuous gas stream, followed by quenching which resulted in condensation of silicon nanoparticles that had monocrystalline crystal structure, and consisted of essentially aggregate-free primary particles with very small (i.e. less than 10 wt. %) passivation layer of SiO₂ on its surface. A mixture of natural crystalline flake graphite of Lac Knife natural resource origin in Quebec, Canada, having purity of 99.95 wt. % C after purification denoted in Example 1B, and the silicon nanoparticles was prepared and enclosed in an airtight vessel under inert gas. The vessel containing the graphite and silicon was placed on rollers for 15 minutes, to ensure complete mixing to provide a premixed composite for further processing.

The premixed composite then underwent a spheroidization process to incorporate the silicon inside the spheroidal graphite particles. The resulting spheroidal Si-graphite particles were further screened to produce a ˜450 mesh product for electrochemical testing. Screening for size took place during the carbon coating process to minimize oversized agglomerates and post-calcination for any additional oversized agglomerates.

### Method B—Si-Graphite Particles (Carbon Coated)

Spheroidal silicon-enhanced graphite particles prepared using Method A were further coated with amorphous carbon to produce carbon coated spheroidal silicon-enhanced graphite particles.

The carbon coated spheroidal Si-graphite particles were further screened to produce a 450 mesh product for electrochemical testing. To prepare the material for electrochemical testing, silicon-enhanced graphite was added into a matrix comprising PVDF binder and acetylene-type carbon black that had high aggregate structure. The anodes were coated on copper foil to have the coated density ranging from 6.24 mg/cm² to 16.20 mg/cm² depending on the test series.

It is worth noting that the carbon coating results in a reduction of the surface area of the spheroidal graphite from 11.6 to 2.7 m²/g and protects the silicon from forming silicon carbide at the surface. Sample data was confirmed with a three-point BET surface area analysis.

Method C-Silicon Addition after Spheroidization

Purified flake graphite was air milled and screened to a maximum particle size of 270 mesh and spheroidized to form spheroidal graphite particles, which were subsequently coated with silicon nanoparticles by tumbling to provide silicon-coated spheroidized graphite particles. The silicon-coated spheroidized graphite particles were then coated with amorphous carbon, to provide an exterior carbon shell on the spheroidal particles. The material for electrochemical testing was prepared as described above for Method B.

### Example 3: Silicon-Enhanced Coin Cell Electrode Configuration

In order to evaluate the electrochemical performance of the silicon-enhanced graphite material, a coin cell (CR2016 configuration) was prepared using the following electrode formulation: 87 wt. % silicon-enhanced graphite material particles, 9.5 wt. % KF polymer PVDF binder (Kureha), and 3.5 wt. % carbon black (Super-P, Imerys Graphite & Carbon), with LP30 electrolyte (1M lithium hexafluorophosphate in ethylene carbonate/dimethyl carbonate (1:1)). The cell was manufactured with an electrode thickness of 8 mil (wet) and 120 μm (dry) to ensure the coated density ranging from 6.24 mg/cm² to 16.20 mg/cm² depending on the test series. The counter electrode was lithium metal having a thickness of 750 μm. The separator was ultrahigh molecular weight polypropylene film of 20 μm thickness (grade: ENTEK GOLD XP, ENTEK Membranes LLC, Lebanon, Oregon, USA). The graphitic material was prepared with varying proportions of nanoparticulate silicon and purified graphite flakes of about D₅₀˜25 μm in particle size.

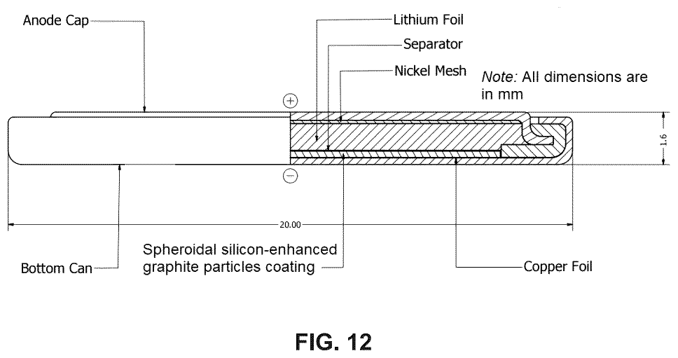

FIG. 12 shows a cutaway view of the CR2016 coin cell employed in the present experiments for assessing the electrochemical performance of the materials. It is a commercially widely accepted test vehicle, CR2016 coin cell with lithium metal counter-electrode, also known as a “half-cell”. Posted dimensions reveal that this cell has a diameter of 20 mm by 1.6 mm height, and is made in an airtight stainless steel housing.

### Electrochemical Performance of Silicon Enhanced Spheroidal Graphite Particles

### Example 4: Galvanostatic Curves for Silicon Enhanced Spheroidal Graphite

Coin cells constructed with the silicon-enhanced graphite particles prepared using Method A above were evaluated.

The initial electrochemical data from the first three cycles of a coin cell containing uncoated spheroidal graphite with 4.5 wt. % silicon added at a C/20 cycling rate indicate that the irreversible capacity of the first cycle's charge was 506.43 mAh/g, and the reversible capacity was 392.2 mAh/g. This translates to an irreversible capacity loss (ICL) of 22.55%. Since the three discharge curves are spaced close together and overlap, it is evident that the cycling was exceptionally stable.

Coin cells containing carbon coated graphite particles with 4.5 wt. % silicon added, prepared using Method B above, were evaluated at a C/20 cycling rate.

Again, the data obtained also show a highly stable cycling performance. The initial electrochemical data from three out of the first five cycles indicate that the reversible capacity was 461.8 mAh/g and the irreversible capacity was 564.97 mAh/g, giving an ICL of 18.26%. The ICL was about 5% lower than the ICL of the uncoated material with the same percent silicon added, while the reversible capacity increased. The coated material performed better than the uncoated material because the silicon was better protected by an outside amorphous carbon shell. Also, it should be noted that the reversible capacity of the carbon coated material was 24% higher than the theoretical capacity that can be achieved with graphite alone.

Uncoated spheroidal graphite with 18% silicon was prepared by the same process that was used for preparing the 4.5 wt. % silicon particles. The galvanostatic curves for the resulting silicon-enhanced graphite particles (18 wt. %) indicate that the irreversible capacity of the uncoated spheroidal graphite with 18% silicon added was 832.83 mAh/g, and reversible capacity was 612.72 mAh/g, producing an ICL of 26.43%. The reversible capacity achieved was 65% higher than the theoretical capacity that can be achieved with graphite alone.

It is clear from the above that the electrochemical performance achieved with testing of the silicon enhanced graphite particles, prepared in accordance with the present invention in lithium ion coin cells, shows an improvement over the plain graphite materials. The data show that, at an addition level of 4.5 wt. % silicon, the application of a carbon coating to the spheroidal graphite particles resulted in an increase in the reversible capacity to 460 Ah/kg which is 24% higher than the theoretical capacity of 372 Ah/kg for graphite alone as compared with a reversible capacity of 392 Ah/kg for the uncoated version. Although coin cell tests at the 18% silicon addition level were only run on the uncoated version of the spheroidal graphite, the reversible capacity did reach 612 Ah/kg which is almost double the capacity that can be achieved with commercially available grades of synthetic and flake graphites without silicon doping. As noted previously, applying a carbon coating to this grade will increase the reversible capacity of the 18 wt. % silicon enhanced graphite even further.

As demonstrated above, the silicon enhanced graphite particles prepared using the processes of the present invention are particularly suitable for use as an advanced lithium ion battery anode material.

### Example 5: Effect of Cycling of Silicon Addition

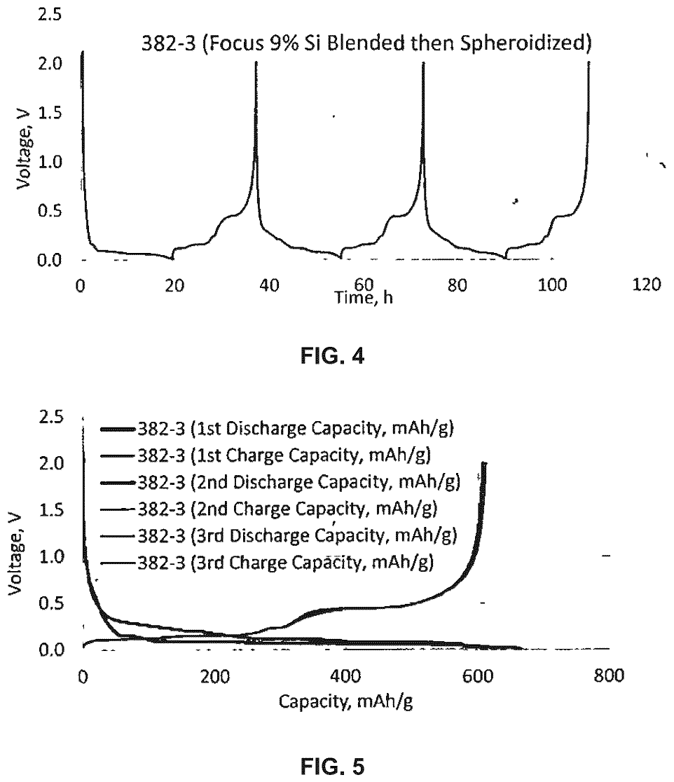

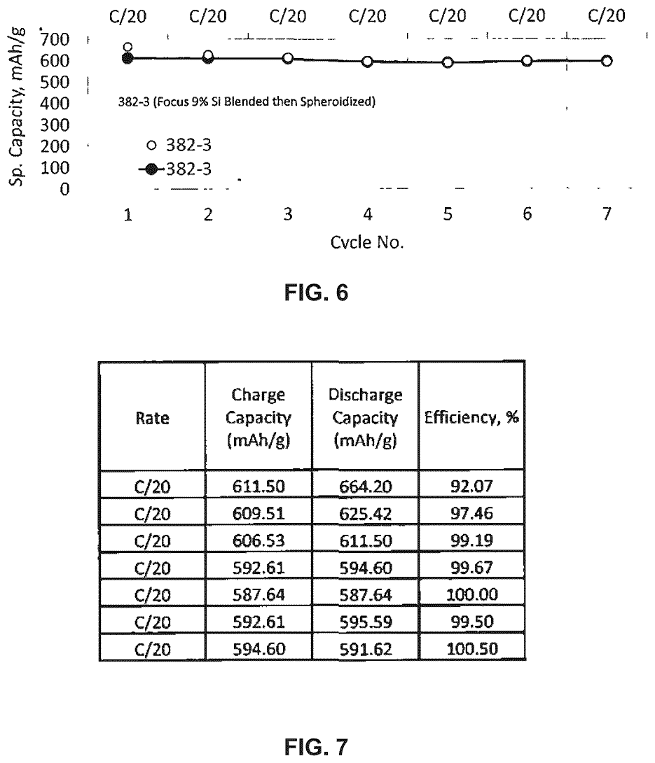

FIGS. 4 to 7 present a summary of electrochemical data obtained upon evaluation of a coin cell (Cell No. 382-3). Cell No. 382-3 was prepared using a carbon coated silicon enhanced graphite particle comprising 9 wt. % silicon prepared using Method B. FIG. 4 depicts the charge-discharge curves for the first three cycles of Cell No. 382-3, FIG. 5 depicts the galvanostatic charge-discharge curves and capacity data for the first three cycles of Cell No. 382-3, FIG. 6 depicts the charge-discharge capacities for the first seven cycles of Cell No. 382-3, and FIG. 7 is a tabular summary of the charge-discharge capacity data for the first seven cycles of Cell No. 382-3.

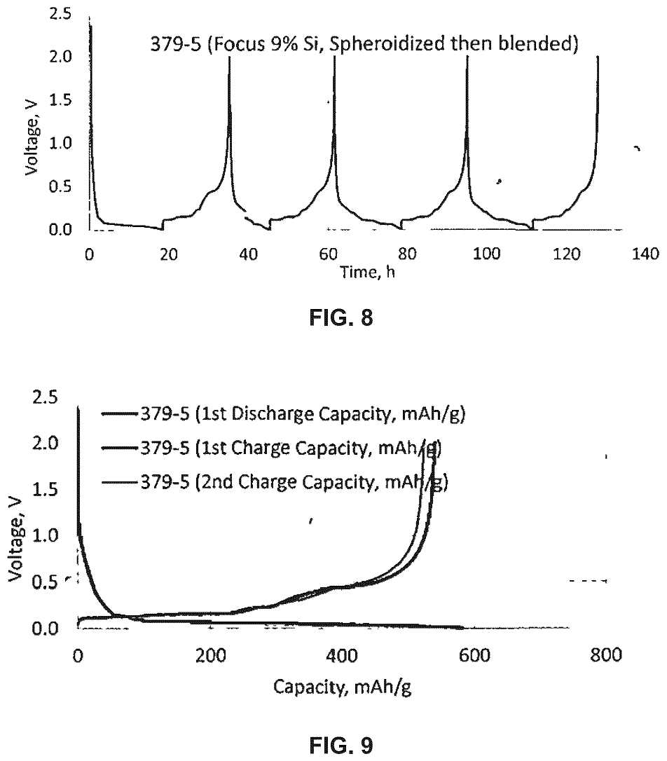

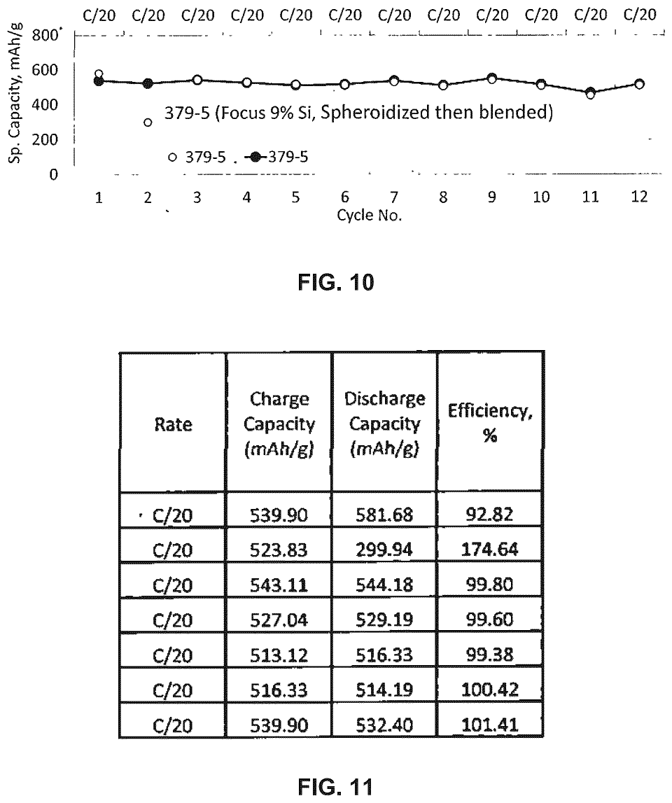

FIGS. 8 to 11 present a summary of electrochemical data obtained upon evaluation of a coin cell (Cell No. 379-5) prepared using a carbon coated graphite particle comprising 9 wt. % silicon added after spheroidization of the graphite, according to Method C. FIG. 8 depicts the charge-discharge curves for the first four cycles of Cell No. 379-5, FIG. 9 depicts the galvanostatic charge-discharge curves and capacity data for Cell No. 379-5, and FIG. 10 depicts the charge-discharge capacity data for the first twelve cycles of Cell No. 379-5, and FIG. 11 is a tabular summary of the charge-discharge capacity data for the first seven cycles of Cell No. 379-5.

It can be seen from a comparison of the average of the charge capacities of the first 7 cycles of a cell made with each sample that the cells made with 9 wt. % Si added before spheroidization (599 mAh/g) is 13% higher than that of cell made with the same amount of Si added after spheroidization (529 mAh/g).

### Example 6: Importance of Correct Balancing of the Electrode Capacities

For proper balancing of the cell's anode to cathode ratio, it is imperative to be able to calculate how much silicon is contained in the battery-ready anode. As it was mentioned earlier, silicon nanoparticles may in fact be comprised of SiO₂-coated Si nanoparticles. The SiO₂ coating is not an active material and the amount of non-active silicon should be well understood before making the battery. On the other hand, some silicon nanoparticles become inevitably lost in the process of making the silicon-enhanced graphite particles. Indeed, not all silicon gets rolled inside the resulting spheroidal particle. Some silicon ends up staying on the surface of the particle and could be shed in the process of material screening and post-spheroidization handling. These factors can contribute to not reaching the theoretical capacity of silicon-enhanced graphite particles based on a notional loading of silicon in graphite.

This example provides a method for determining the mass of silicon (Si) in a given graphite sample doped with Si, through a stochiometric calculation based on data from the Loss on Ignition (LOI) test. In this experiment, approximately 1 gram of silicon-enhanced graphite composite is oxidized in a muffle furnace. At a temperature of 950° C., pure graphite burns away and impurities (in the form of ash) remain; the final mass of the impurities after six hours in the oven allows the purity percentage to be calculated.

There are a few assumptions made herein. Firstly, one assumes that, during LOI, all Si contained within the graphite sample oxidizes to silicon dioxide (SiO₂) using Formula 1 below:

Si+O₂→SiO₂ (1)

This is a reasonable assumption, as the above reaction is endothermic and LOI takes place at the very high temperature of 950° C. The second assumption is that all of the ash, except for what was in the graphite sample before the addition of silicon, remaining after the period of six hours is comprised of SiO₂. This is a safe inference to make if the pre-silicon-doped graphite was previously tested and its impurity content is subtracted from the second round of LOI's ash. If the already very pure graphite was not contaminated outside of its doping, the only element to oxidize would, in fact, be silicon.

From here, stoichiometry may be utilized. LOI data provides the mass of ash remaining after the sample's time in the furnace minus the original graphite's impurity mass, whose difference, as stated above, may be assumed to be the mass of SiO₂. This relationship is described in Formula 2:

$$Y g ash from round 2 LOI - Z g ash from round 1 of LOI = X g {SiO}_{2} \qquad ( 2 )$$

The molar mass of silicon dioxide is calculated below in Formula 3:

$$\frac{\text{?} g}{mol} St \times \frac{1 mol \text{?}}{mol {SiO}_{2}} + \frac{\text{?} g}{mol} O \times \frac{2 mol \text{?}}{mol {SiO}_{2}} = 60.083 \frac{g}{mol} {SiO}_{2} \qquad ( 3 )$$

$$\text{?} \text{indicates text missing or illegible when filed}$$

The molar mass of pure silicon is 28.085 grams per mole as stated in Formula 3. All of the above may be combined in Formula 4 to calculate the mass of Si in a sample of graphite after undergoing LOI:

$$X g {SiO}_{2} \times \frac{\text{?}}{\text{?} g} \times \frac{1 mol \text{?}}{1 mol {SiO}_{2}} \times \frac{\text{?} g}{mol \text{?}} = 0.46744 X g St \qquad ( 4 )$$

$$\text{?} \text{indicates text missing or illegible when filed}$$

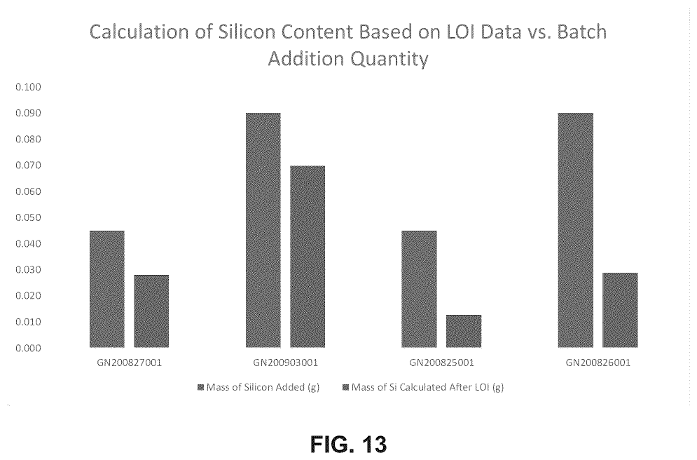

In other words, the mass of silicon originally in a Si-doped sample of graphite may be calculated as 0.46744 times the mass of ash produced. This calculation may be executed using LOI data and the subsequent masses of silicon dioxide and silicon. Firstly, perform loss on ignition on a sample of graphite to be doped with Si. Then, complete the doping and note the mass percent of silicon added to the batch of graphite. This percentage may be divided by 100 to find the expected mass of silicon in a one-gram sample, and this can be compared to the actual quantity of silicon in the sample calculated in Formula 4. A number of samples doped at 2.25%, 4.5%, 9.0% and 13.5% were evaluated using this method, and the following data and charts are produced: FIG. 13 is a graphical depiction of the actual silicon content based on LOI data versus the batch addition quantity.

TABLE 1
Theoretical v. actual loading of Si in silicon-
enhanced graphite anodes per Methods B and C.

| | | Mass of | Mass of Si |
|---|---|---|---|
| | | Silicon | Calculated |
| GN Number | Description | Added (g) | After LOI (g) |
| GN200827001 | Blended before | 0.045 | 0.028 |
| | spheroidization | | |
| GN200903001 | Blended before | 0.090 | 0.070 |
| | spheroidization | | |
| GN200825001 | Doped after | 0.045 | 0.013 |
| | spheroidization | | |
| GN200826001 | Doped after | 0.090 | 0.029 |
| | spheroidization | | |

It is apparent from the data presented in Table 1 that silicon-enhanced graphite composites produced through Method B (silicon doping before spheroidization) retain a greater loading of silicon than the materials produced via Method C (silicon doping after spheroidization).

### Example 7: Method B v. Method C Electrochemical Performance Comparisons

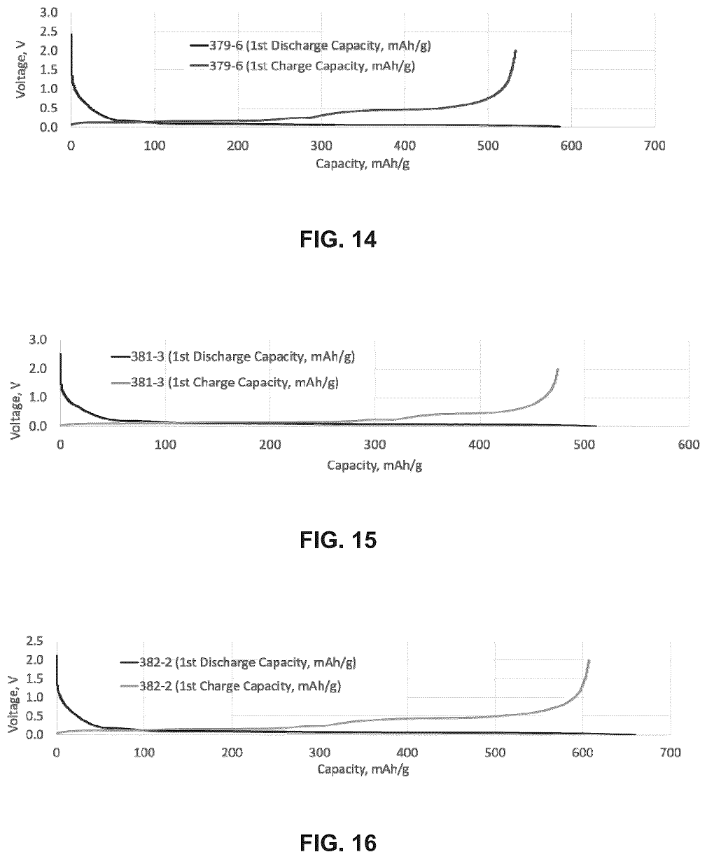

This experiment is graphically summarized by FIGS. 14 through 17.

Four series of cells were built and assessed in this example. The first two cell series (Series 379 and 381) were constructed from silicon-enhanced graphite anodes in accordance with Method C, described above. That is, silicon nanoparticles were added after formation of spheroidized purified natural graphite with a D₅₀ of 25 μm and then carbon coated. Within this group, Series 379 had 9 wt. % addition of silicon and Series 381 had 4.5 wt. % addition. The second experimental series (Series 382 and 389) incorporated silicon-enhanced graphite produced through Method B: A D₅₀=25 μm purified natural graphite was first mixed with silicon nanoparticles under a blanket of argon gas, then the mixture was spheroidized so that the silicon particles were incorporated inside the spheroidal particles. An exterior carbon coating was applied on the outer layer of the resultant particle. Series 382 utilized 9% silicon addition and Series 389 had 4.5% addition.

The initial formation cycling results for these four experimental series are provided in FIGS. 14 through 17, as follows.

FIG. 14 depicts the galvanostatic charge-discharge curves for Coin Cell No. 379-6 made with carbon coated SPG with the addition of 9 wt. % silicon after spheroidization, prepared using Method C.

FIG. 15 depicts the galvanostatic charge-discharge curves for Coin Cell No. 381-3 made with carbon coated SPG with the addition of 4.5 wt. % silicon after spheroidization, prepared using Method C.

FIG. 16 depicts the galvanostatic charge-discharge curves for Coin Cell No. 382-2 made with carbon coated SPG with the addition of 9 wt. % silicon prior to spheroidization, prepared using Method B.

FIG. 17 depicts the galvanostatic charge-discharge curves for Coin Cell No. 389-2 Made with carbon coated SPG with the addition of 4.5 wt. % silicon prior to spheroidization, prepared using Method B.

### Example 8: Galvanostatic Curves for Coin Cells Comprising Silicon Enhanced Spheroidal Graphite Containing Varying Amounts of Silicon

This embodiment describes experimental test work conducted in CR2016 coin cells which were all constructed in the same manner as described in Example 3. The only difference in the presented series of data was the anode composition, or negative electrode of the cells.

The anode of the Series 1A cell was assembled from spheroidized Lac Knife natural crystalline flake graphite which contains 13 wt. % of silicon incorporated into the graphite spheroid. This material was then carbon coated. The Series 1B cell incorporated 9 wt. % of silicon placed inside the graphite spheroid and carbon coated. The Series 1C cell contained 4.5 wt. % of silicon which was incorporated into a graphite spheroid and then carbon coated. The Series 1D was made using 2.25 wt. % of silicon incorporated inside a graphite spheroid and then carbon coated.

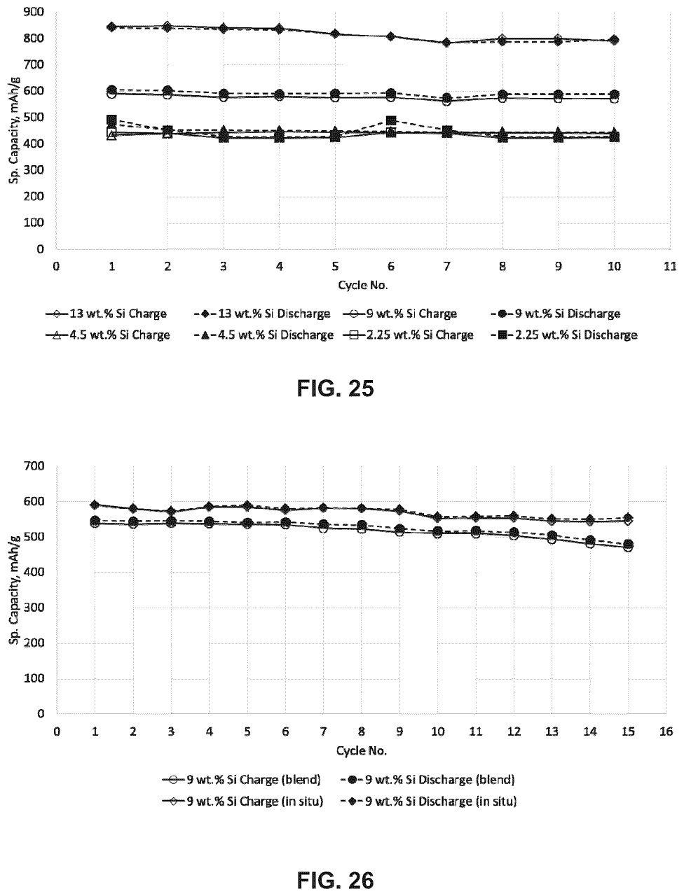

FIG. 25 shows a summary graph of charge and discharge maximums of the specific capacity, measured in mAh/g, as a function of the cycle number for Series 1A, 1B, 1C and 1D cells. These test series were run for ten consecutive cycles. The data shows that the specific capacity of Series 1A cell ranges from 840 to 796 mAh/g and represents a fairly stable discharge curve with a minor sign of depression as a function of the cycle life. The Series 1B cell had a much flatter discharge curve than the Series 1A and had a specific capacity ranging from 604 to 588 mAh/g. The Series 1C and 1D cells displayed very similar specific capacities that ranged from 492 to 443 mAh/g. These cells had the flattest discharge curves for all of the series tested.

From this figure, it is clear that the lower the percentage of silicon incorporated into the spheroidal graphite particles, the more stable the discharge curve or the lower the specific capacity of the anode. The only exception is the minor difference seen between the cells containing 2.25 and 4.5 wt. % of silicon which indicates that the specific capacities are basically the same.

For all four series, the measured specific capacities were significantly greater than the theoretical specific capacity of pure natural graphite anode which is 372 mAh/g and than the practical reversible capacity of Lac Knife graphite, Standard Grade CSPG, of 358.8 mAh/g, as seen from FIG. 24, above.

FIG. 25 shows the all cycle discharge/charge maximums for the Lac Knife Spheroidized Natural Flake Graphite incorporated with silicon, loaded at 2.25 (Series 1D), 4.5 (Series 1C), 9 (Series 1B) and 13 (Series 1A) wt. % respectively, and carbon coated. C/20 charge-discharge rate, CR2016 coin cell; every cycle in the range from 1 to 10 is shown.

Therefore, incorporating silicon inside a spheroidal graphite particle and then carbon coating the resultant particle ensued in the creation of a new and improved anode active material whose specific capacity will on average be greater than the theoretical capacity of lithium intercalation into graphite is greater by 54.5% for Series 1A, 37.6% for Series 1B, and approximately 20.4% for both Series 1C and 1D formulations. In conclusion, placing silicon inside the graphite particles not only achieves a stable performance, but it also performs notably better than solely pure graphite.

This experiment was expanded to include data series described in Examples 9 and 10, below.

### Example 9: Comparison of Coin Cells Comprising 9 wt. % Silicon Containing Spheroidal Graphite Prepared by Spheroidization Process Vs Physical Blending Process

In this embodiment, two series of CR2016 cells were assembled (see Example 3 for construction of CR2016 cell). The first series in this example, Series 2A, consisted of cells containing 9 wt. % of silicon incorporated into the spheroidal graphite shell using the spheroidization process, which was then carbon coated with a layer of soft carbon. The second series in this example, Series 2B, had cells composed of a physical blend of natural spheroidal carbon coated graphite and carbon coated silicon nanoparticles of the same particle size, dimension, and origin as the silicon particles used in Series 2A. Both series of cells were subjected to a cycling C/20 charge/discharge rate and their specific capacity values are presented in FIG. 26. The y-axis shows the specific capacity measured in mAh/g and the x-axis shows the cycle number. The test was conducted over the course of 15 cycles.

FIG. 26 shows all cycle discharge/charge maximums for the Lac Knife spheroidized natural flake graphite with silicon, loaded at 9 wt. % (Series 2A), and a physical blend of 9 wt. % silicon with natural spheroidal carbon coated graphite (Series 2B), respectively, both carbon coated. C/20 charge-discharge rate, CR2016 coin cell; every cycle in the range from 1 to 15 is shown.

Several observations were noted from these tests. The specific capacity values for the silicon particles incorporating inside a natural graphite sphere is notably higher than the blended anode material. For example, on cycle number 5, the anode containing the silicon and graphite blend had a specific capacity of 540.18 mAh/g while the composite containing silicon inside the natural graphite had a specific capacity of 588.63 mAh/g. In this particular instance, a 9.0% improvement was observed by putting silicon inside the graphite particle.

Another observation from this series is that the specific capacities of Series 2B showed signs of rapid degradation after cycle 12 while Series 2A remained very stable. In conclusion, the incorporation of silicon inside a graphite particle leads to an improved overall specific capacity and an improved stability of the specific capacity.

### Example 10: Comparison of Coin Cells Comprising 2.25 wt. % Silicon Containing Spheroidal Graphite Prepared by Spheroidization Process vs Physical Blending Process

In this embodiment, two series of CR2016 cells were assembled (see Example 3 for construction of CR2016 cell). Series 3A cells were assembled using an anode constructed from a composite particle whose core was made up of 2.25 wt. % silicon incorporated into a spheroidal graphite shell using the spheroidization process, which was then carbon coated. Series 3B cells were produced from an anode which developed from a physical blend of Lac Knife natural crystalline spheroidized carbon coated flake graphite and carbon coated silicon nanoparticles of the same particle size, dimension, and origin as the silicon particles used in Series 3A.

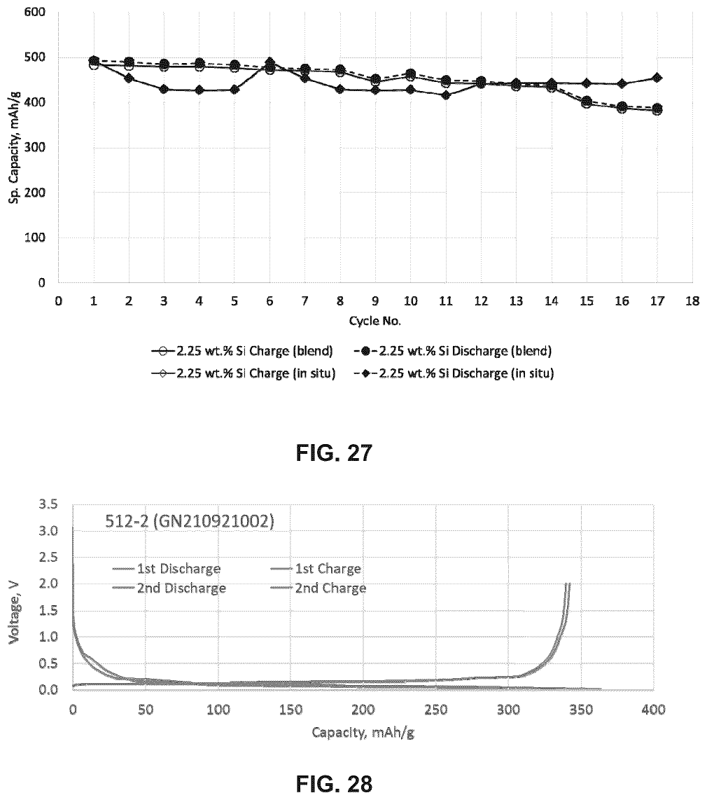

FIG. 27 presents the cycle data in the form of a graph of the specific capacity values dependent on the cycle number.

FIG. 27 shows all cycle discharge/charge maximums for the Lac Knife spheroidized natural flake graphite with silicon, loaded at 2.25 wt. % (Series 3A), and a physical blend of 2.25 wt. % silicon with natural spheroidal carbon coated graphite (Series 3B), respectively, both carbon coated. C/20 charge-discharge rate, CR2016 coin cell; every cycle in the range from 1 to 15 is shown.

One can see that other than for the minor noise in data, the initial charge/discharge specific capacity for both formulations is very similar and constitutes a value of around 492 mAh/g. After some initial noise in the data, the specific capacity of the cell from Series 3A stabilized by cycle 12 and remained quite flat through the reported 17 cycles. By cycle 17, Series 3A had a specific capacity value of 453.28 mAh/g. The cell containing the silicon and graphite blend from Series B remained stable for the first 14 cycles and then began to show a significant decay in specific capacity. This cell started from a specific capacity of 491.75 mAh/g and ended at 386.44 mAh/g.

From this study, it was concluded that the addition of the silicon to the anode in the form of a physical blend at 2.25 wt. % of silicon loading has limited utility after 14 cycles as there was a significant degradation of this anode thereafter. This is not observed in the cell with the anodes that incorporate 2.25 wt. % of silicon nano-particles using the spheroidization process.

### Example 11: Effect of Addition of High Structure (Amorphous) Carbon Black at Agile Matrix Facilitating Long-Term Cycling of Silicon-Enhanced Graphite Anodes

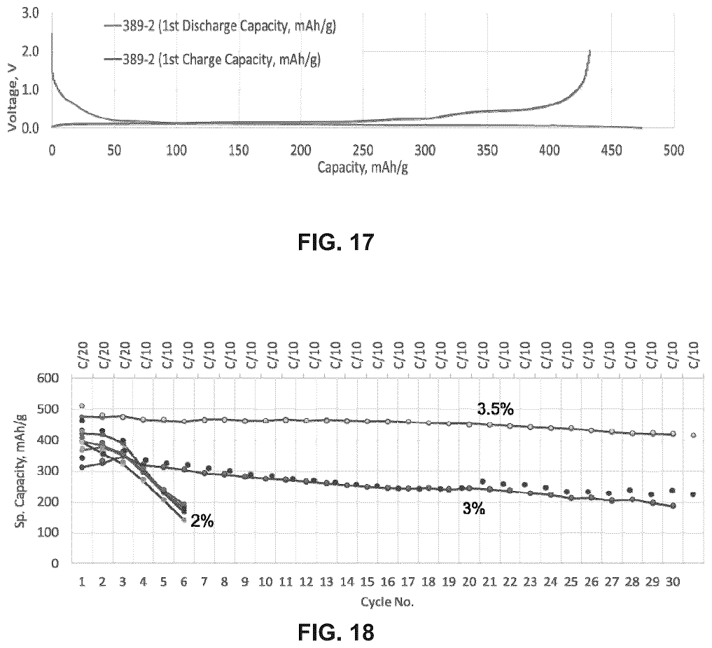

An electrochemical experiment consisting of three series was established. It contained the same grade of silicon-enhanced graphite, however, the difference was in the electrode assembly. The first series contained 2% addition of high-structure carbon black Super P by Imerys Graphite and Carbon, and the second and third series contained 3% and 3.5% addition of the same material, respectively. The long-term cycling graph presented in FIG. 18 clearly points to the benefit of the addition of higher loadings of carbon black. Without being limited by theory, it is believed that this is because carbon black creates a cushioning and agile matrix facilitating the volumetric expansion of silicon-enhanced graphite particles. In doing so, electrical conductivity throughout the bulk of the silicon-graphite anode is not sacrificed and the electrode continues to function. Insufficient loadings of carbon black lead to premature cell failure. At the same time, it was found that there is an optimal percent addition of carbon black. it appears that over-addition of carbon black would lead to reduced active component loadings in the anode, as well as an increase in the irreversible capacity loss of the anode. Therefore, it has been established that an optimal range within 0.5-5 wt. % addition of carbon black materials which allows to achieve the claimed range of electrode density in terms of active material loading (i.e. from 6.24 mg/cm² to 16.20 mg/cm²).

### Example 12: Blend of Synthetic and Natural Graphite, Both Independently Purified, Spheroidized and Carbon Coated

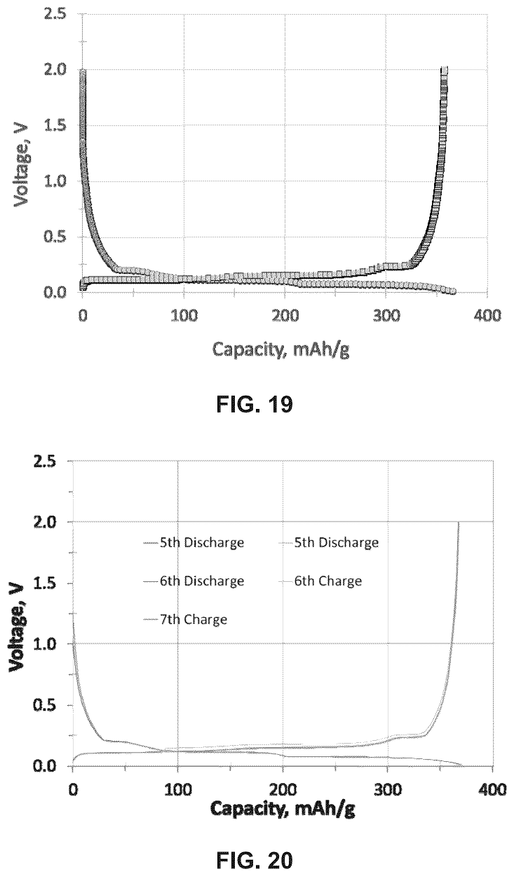

The CR2016 coin cell has been assembled as per the process described in Example 3. The active material on the negative electrode was assembled by creating a physical blend of two components. The first component was a thermally purified spheroidized carbon coated natural crystalline flake graphite of Lac Knife resource origin in Quebec, Canada. The flake graphite with particle size of D₅₀=25 μm was taken at 97.75 wt. % of the overall graphite composition in the anode. The second component was a carbon coated densified primary synthetic graphite whose particle size was D₅₀=12 μm. This material is commercially available from American Energy Technologies Company (AETC), Arlington Heights, IL under the grade name SAM-1228. The synthetic graphite material was blended at 2.25 wt. % loading level of the total graphite content composition. The electrochemical cell underwent a typical formation regime for the first four cycles which are omitted from FIG. 19, which shows the fifth cycle displaying lithium deintercalation (removal of lithium ions from particle) capacity of 357.07 mAh/g and intercalation capacity of 365.14 mAh/g. This level of performance is very typical for a blend of classic natural and primary synthetic graphite and represents very robust but expected levels of performance. This result is used as a reference point in Example 13.

FIG. 19 shows the galvanostatic charge-discharge curves of the CR2016 coin cell prepared in Example 12.

### Example 13: Composite Particle Based on Co-Processed Synthetic and Natural Graphite, Both Purified, Spheroidized and Carbon Coated

The CR2016 electrochemical coin cell has been assembled in using the process described in Example 12 with the exception that the anode active material was assembled using a composite produced by spheroidization of a mixture of synthetic and natural graphite; the composite was classified to particle size of D₅₀=23 μm and carbon coated. The ratio of natural to synthetic graphite was maintained at the same level as in Example 12: specifically the composite contained 97.75 wt. % of Lac Knife natural crystalline flake graphite with 2.25 wt. % of primary synthetic graphite. The spheroidization process was conducted in a way that synthetic graphite was incorporated into the larger sphere made of natural graphite, which was then carbon coated.

This cell underwent a typical electrochemical formation cycle for four cycles whose details are omitted from FIG. 20. In FIG. 20, the galvanostatic charge and discharge curves for cycles number 5 through 7 are shown. The performance of composite graphite anode reveals a notable increase in the level of both reversible and irreversible capacity observed. For reference, the theoretical capacity of lithium intercalation into graphite is 372 mAh/g. Many battery scientists believe that it is hardly possible to achieve theoretical capacity; therefore, the majority of strong performing graphite materials display reversible capacities of around 355-357 mAh/g which was the case depicted in Example 12. Unexpectedly, a composite material prepared using the processes of the present invention surprisingly displayed near theoretical values of performance, consistently delivering capacities of around 367 mAh/g. This is an unexpected result signaling a trend that incorporating synthetic graphite into a natural graphite-based shell using the present spheroidization processes produces more capacity than the expected reversible capacity delivered through the simple physical blending of two graphites.

FIG. 20 shows the galvanostatic charge-discharge curves of a coin cell containing the co-processed (spheroidized) composite of Example 13.

Example 14: Determining Sustainability of the Effect of an Unexpected Increase of Capacity in Composite Particles Having Synthetic Graphite Core, Natural Graphite Shell and an Outer Shell Made of Soft Carbon Coating

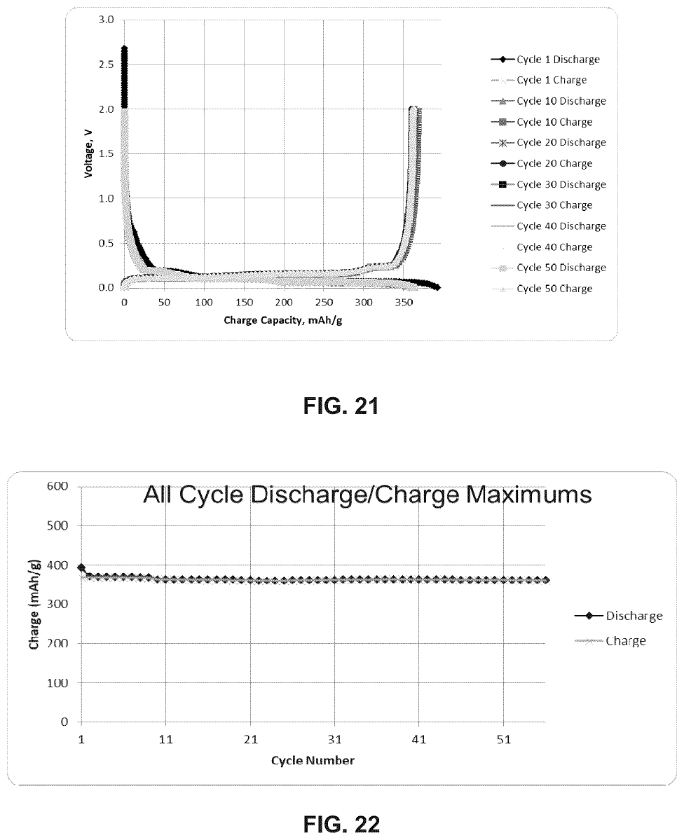

The purpose of the embodiment provided by Example 14 was to evaluate the possibility of achieving stable performance by cycling the composite, where primary synthetic graphite is incorporated into a larger spheroidal graphite particle cell using the present spheroidization process and then the resultant particle is carbon coated. The CR2016 coin cell was constructed in accordance with the process of Example 3. A series of three cells was constructed; however, to avoid unnecessary noise in reporting very similar data, the results obtained from a single cell are presented. FIG. 21 shows overlays of intercalation and deintercalation curves recorded at C/10 (battery has been completely discharged and charged over a period of 10 hours of each semi-cycle) for cycles 1, 10, 20, 30, 40, 50. The resultant cycles reveal great similarities and produce no notable decay in capacity going from cycle to cycle. Furthermore, FIG. 22 shows an overlay of the actual charge and discharge curves for all cycles in the reported test series ranging from 1 through 56. Data presented in FIG. 21 is also formatted as a tabular format in Table 2 below to verify the performance for these curves being extremely flat (hardly noticeable change in capacity from cycle to cycle). The reversible capacity seen by charge column reveals near theoretical performance where the experimental values range between 360 to 368 mAh/g providing evidence of very negligible degradation and revealing signs of very high performance stability.

FIG. 21 presents an overlay of galvanostatic charge-discharge curves for coin cells prepared in Example 14. Every tenth cycle in the range from 1 to 50 is shown in data overlay.

FIG. 22 presents all cycle discharge/charge maximums for the coin cell prepared according to Example 14. C/10 charge-discharge rate, CR2016 coin cell; every cycle in the range from 1 to 57 is shown.

TABLE 2
Individual Cycle Data for FIG. 22

| Cycle Number | Discharge | Charge |
|---|---|---|
| 1 | 392.8539 | 368.1078 |
| 2 | 371.7814 | 368.3254 |
| 3 | 370.5199 | 368.1318 |
| 4 | 369.2634 | 367.8937 |
| 5 | 369.5977 | 368.0008 |
| 6 | 369.4480 | 367.9633 |
| 7 | 369.1319 | 367.8254 |
| 8 | 368.6460 | 367.4438 |
| 9 | 368.3436 | 367.0466 |
| 10 | 363.6199 | 362.7942 |
| 11 | 363.6763 | 362.8350 |
| 12 | 363.2161 | 362.4325 |
| 13 | 362.7382 | 361.9921 |
| 14 | 362.6112 | 361.8743 |
| 15 | 362.4268 | 361.7484 |
| 16 | 362.3740 | 361.6939 |
| 17 | 362.5541 | 361.8993 |
| 18 | 362.7764 | 362.1207 |
| 19 | 362.5701 | 359.7959 |
| 20 | 361.3555 | 360.8156 |
| 21 | 360.8217 | 360.2782 |
| 22 | 360.1646 | 359.6772 |
| 23 | 360.2187 | 359.6995 |
| 24 | 359.7940 | 359.3097 |
| 25 | 359.4568 | 359.0195 |
| 26 | 360.9534 | 360.4763 |
| 27 | 360.9763 | 360.4653 |
| 28 | 360.8614 | 360.4133 |
| 29 | 361.2790 | 360.7722 |
| 30 | 361.5713 | 361.1067 |
| 31 | 361.9484 | 361.4500 |
| 32 | 362.3998 | 361.9038 |
| 33 | 362.6104 | 362.0946 |
| 34 | 362.4728 | 361.9645 |
| 35 | 362.4130 | 361.9254 |
| 36 | 362.8455 | 362.3383 |
| 37 | 363.3698 | 362.8846 |
| 38 | 363.3832 | 362.8554 |
| 39 | 362.4629 | 362.8600 |
| 40 | 363.2459 | 362.7044 |
| 41 | 362.9560 | 362.4387 |
| 42 | 362.6069 | 362.1183 |
| 43 | 362.6820 | 362.2395 |
| 44 | 362.9878 | 362.4207 |
| 45 | 362.1633 | 361.6844 |
| 46 | 361.7329 | 361.2976 |
| 47 | 361.7222 | 361.2798 |
| 48 | 361.7537 | 361.2559 |
| 49 | 361.3228 | 360.9158 |
| 50 | 361.9345 | 361.5084 |
| 51 | 361.7244 | 361.2671 |
| 52 | 361.2931 | 360.8708 |
| 53 | 361.2371 | 360.7883 |
| 54 | 361.2040 | 360.7691 |
| 55 | 360.8600 | 360.4334 |
| 56 | 360.5235 | 360.0962 |

The description of this embodiment would be incomplete without the depiction of individual charge-discharge capacities of the two ingredients of the blend described in Example 12 and a composite particle as described in Examples 13 and 14, above.

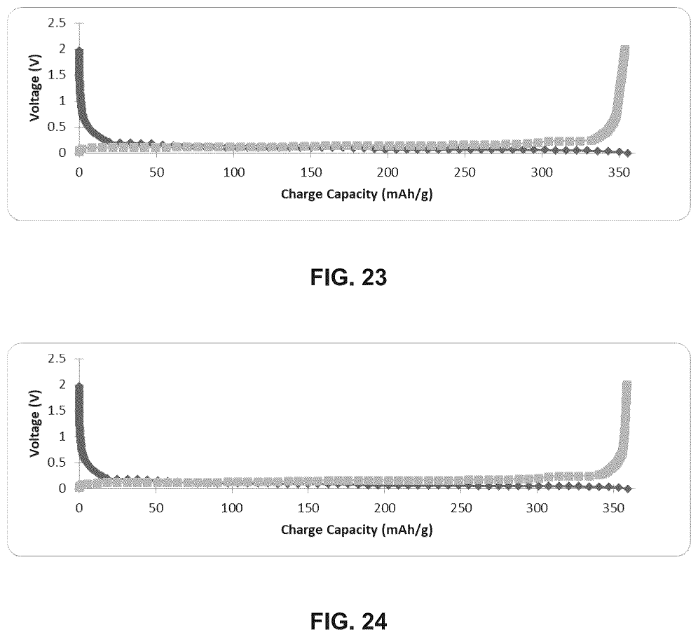

Electrochemical cells of CR2016 construction were made according to the process described in Example 3. In the first series of control material (presented by FIG. 23) the anode active material was densified thermally treated synthetic graphite grade SAM-1228, having particle size of D₅₀=12 μm. The grade is commercially available from American Energy Technologies Co. of Illinois. After formation cycling, at C/10 rate, its reversible capacity is 353.9 mAh/g on de-intercalation and 355.7 mAh/g on intercalation. FIG. 23 shows the galvanostatic charge-discharge curves of a CR2016 coin cell prepared using this control synthetic graphite anode active material.

Electrochemical cells of CR2016 configuration were made as per Example 3 description. In the second series of control material (presented by FIG. 24) the anode active material was spheroidized, thermally purified carbon coated natural crystalline flake graphite grade Standard Grade CSPG, having particle size of D₅₀=23 μm and available from Focus Graphite's Lac Knife natural deposit in Quebec, Canada. After formation cycling, at C/10 rate, its reversible capacity was measured as 358.8 mAh/g on de-intercalation and 359.5 mAh/g on intercalation. FIG. 24 shows the galvanostatic charge-discharge curves of a CR2016 coin cell prepared using this control natural graphite anode active material.

It can be easily seen that the performance of control materials, while very solid, is deficient when compared with the capacity of an composite formed using the spheroidization process of the present invention, while it is consistent with performance observed for the physical blend of the two materials. Overall, it can reasonably be concluded from this data that the spheroidization process formed composite synthetic and natural graphite is both above the expected performance of the blended materials, and additionally attains greater stability across many charge-discharge cycles. Many more cycles can be carried on seeing the same stability; however, even the limited cycling data of 57 cycles presented by FIG. 22/Table 2 supports this trend.

### Example 15: Physical Blend of a High Loading Densified Synthetic Graphite and Natural

### Purified, Spheroidized and Carbon Coated Graphite.

Using the process similar to that described in Example 12, a lithium-ion battery negative active material was prepared, comprising a physical blend of purified and densified synthetic graphite and purified spheroidized natural graphite with carbon coating applied to both ingredients. The first component was densified carbon coated synthetic graphite SAM-1228 with particle size of D₅₀=12 μm, which was blended at 25 wt. % of the overall graphite composition in the anode. The second component was thermally purified spheroidized carbon coated natural crystalline flake graphite of Lac Knife resource origin in Quebec, Canada with a D₅₀=25 μm, known as Standard Grade CSPG and available from Focus Graphite, Inc. The natural graphite component was blended at 75 wt. % loading to the anode active material.

The CR2016 electrochemical coin cell was assembled using the process described in Example 3 with the exception that the anode active material was assembled with a composite produced by blending densified carbon coated synthetic (25 wt. % loading) and spheroidized carbon coated natural graphite (75 wt. % loading).

The electrochemical cell underwent a typical formation regime at 20 hours of discharge and 20 hours of charge for two cycles (battery was completely discharged and charged over a period of 20 hours of each semi-cycle) and then two more cycles at a higher rate of 10 hours of discharge and 10 hours of charge which were followed by 20 hours of discharge and 20 hours of charge during further cycles. In FIG. 28, the first two galvanostatic discharge and charge curves cycled at 20 hours discharge and charge are shown. The performance of a composite graphite anode of this high loading of additive example reveals stable reversible capacity of 342 mA*h/g with the coulombic efficiency of 94% on the first cycle.

### Example 16: Composite Particle Based on Spheroidized Composite of a High Loading Synthetic Graphite Inside Natural Graphite

The CR2016 electrochemical coin cell was assembled in the same manner as it is described in the aforementioned Example 15 with the exception that the anode active material was prepared using a composite produced by spheroidization of a mixture of synthetic graphite with particle size of D₅₀=12 μm and Lac Knife natural crystalline flake of D₅₀=25 μm. The synthetic graphite was incorporated inside the natural graphite particles to form a spheroidized composite classified to particle size of Dsc=23 μm. After carbon coating the particle size was measured to be D₅₀=24 μm. The ratio of natural to synthetic graphite was maintained at the same level as in Example 15: specifically, the composite was composed of 75 wt. % of Lac Knife natural crystalline flake graphite with 25 wt. % of primary synthetic graphite.

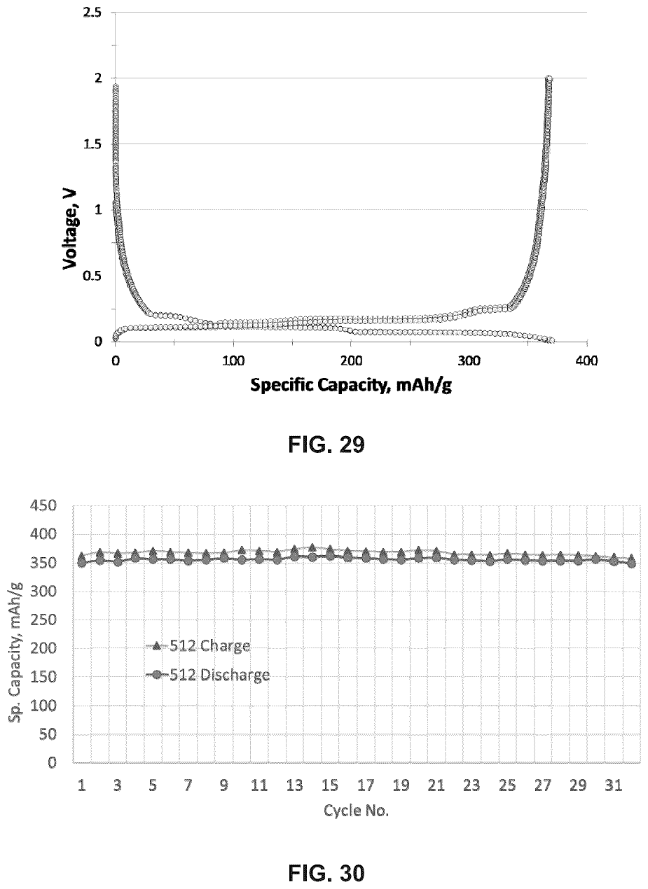

The resulting CR2016 electrochemical coin cell underwent a typical formation regime at 20 hours of discharge and 20 hours of charge for two cycles (battery was completely discharged and charged over a period of 20 hours of each semi-cycle), which was followed by two more cycles at a higher rate of 10 hours of discharge and 10 hours of charge, which in turn was followed by 20 hours of discharge and 20 hours of charge in further cycles. In FIG. 29, the first two galvanostatic discharge and charge curves cycled at a 20 hour cycling rate are shown. The performance of composite graphite anode reveals a very appreciable increase in the reversible capacity to 367.87 mA*h/g (see FIG. 29), as well as an increase in the first cycle efficiency to 99.37%.

Example 17: Determining Sustainability of Performance of Composite Materials Based on a Blend of 25 wt. % Synthetic and 75 wt. % Natural Graphite v. Co-processed Synthetic and Natural Graphite, Taken at Similar Ratio, Both Independently Purified and Carbon Coated

The purpose of Example 17 was to evaluate the electrochemical cycling sustainability of composite materials based on physical blending of synthetic and natural graphite v. co-processing (spheroidizing) a mixture of synthetic and natural graphite depicted in Examples 15 and 16.

FIG. 30 shows a sequence of 32 charge/discharge cycles for the physically blended graphite particles composed of 25 wt. % densified, carbon coated synthetic graphite grade SAM-1228 and 75 wt. % of spheroidized, carbon coated Lac Knife natural graphite (Standard Grade CSPG). The specific capacities of lithium intercalation and deintercalation into the graphite lattices recorded at C/20 rate (i.e. battery has been completely discharged and charged over a period of 20 hours of each semi-cycle) of a representative cell in the series is shown. This cell delivered approximately 350-360 mA*h/g at C/20 rate. The cell is denoted as series #512 in FIG. 30. Data presented in FIG. 30 is also presented in tabular format in Table 3.

Charge-discharge cycling showed about 3% capacity hysteresis between cycles. The composite formed by blending the synthetic graphite and the natural graphite, in which the individual ingredients differ in particle size, likely have different lithium diffusion rates, which causes the aforementioned capacity hysteresis.

TABLE 3
Individual Cycle Data for FIG. 30.

| Cycle No. | Discharge Capacity (mAh/g) |
|---|---|
| 1 | 350.15 |
| 2 | 354.41 |
| 3 | 351.21 |
| 4 | 357.60 |
| 5 | 356.53 |
| 6 | 356.53 |
| 7 | 353.34 |
| 8 | 355.47 |
| 9 | 357.60 |
| 10 | 355.47 |
| 11 | 356.53 |
| 12 | 355.47 |
| 13 | 360.79 |
| 14 | 359.73 |
| 15 | 361.86 |
| 16 | 358.66 |
| 17 | 357.60 |
| 18 | 356.53 |
| 19 | 355.47 |
| 20 | 357.60 |
| 21 | 358.66 |
| 22 | 355.47 |
| 23 | 354.41 |
| 24 | 352.28 |
| 25 | 356.53 |
| 26 | 354.41 |
| 27 | 353.34 |
| 28 | 353.34 |
| 29 | 353.34 |
| 30 | 356.53 |
| 31 | 352.28 |
| 32 | 349.08 |

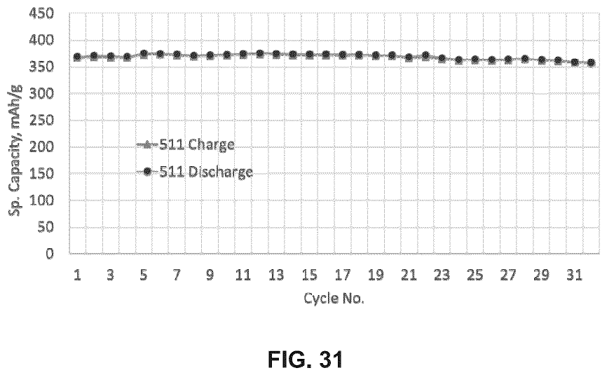

By contrast, FIG. 31 shows a series of 32 charge/discharge cycles for the composite graphite particles which were co-processed as follows: purified spheroidal Lac Knife natural graphite (Standard Grade SPG) and purified densified synthetic graphite, SAM-1228 were co-processed at a ratio of: 75/25 wt./wt. %, respectively, followed by applying an outer shell made of soft carbon onto a composite particle which, in turn, incorporated synthetic graphite component insitu of a natural graphite shell (see description in Example 17). FIG. 31 shows a representative from the #511 battery cell series, whose cycling performance is illuminated by the maximum values of specific capacities of lithium intercalation and deintercalation into the graphite host crystal lattices, as recorded at C/20 rate (i.e. the battery has been completely discharged and charged over a period of 20 hours of each semi-cycle). The cell 511 delivered capacities of around 370 mA*h/g, which is equal to the theoretical capacity of graphite during lithium intercalation and deintercalation at C/20 rate. The synthetic graphite trapped inside natural graphite shell and coated with the soft carbon coating didn't display any charge-over-discharge capacity hysteresis during its cycling at C/20 rate, and retained very stable capacity over the reported 32 cycles. Data presented in FIG. 31 is also presented in tabular format in Table 4

TABLE 4
Individual Cycle Data for FIG. 31.

| | Charge | Discharge | |
|---|---|---|---|
| | Capacity | Capacity | |
| Cycle No. | (mAh/g) | (mAh/g) | Efficiency, % |
| 1 | 366.7712 | 368.0891 | 99.64 |
| 2 | 367.9196 | 370.2637 | 99.37 |
| 3 | 367.496 | 369.2376 | 99.53 |
| 4 | 367.1006 | 368.0326 | 99.75 |
| 5 | 373.0125 | 374.3869 | 99.63 |
| 6 | 373.5773 | 373.8786 | 99.92 |
| 7 | 371.1862 | 372.7395 | 99.58 |
| 8 | 369.3035 | 370.1413 | 99.77 |
| 9 | 370.2072 | 371.3463 | 99.69 |
| 10 | 371.0356 | 371.8829 | 99.77 |
| 11 | 372.5889 | 373.4361 | 99.77 |
| 12 | 373.9539 | 375.0553 | 99.71 |
| 13 | 372.9937 | 374.0857 | 99.71 |
| 14 | 371.5345 | 372.8054 | 99.66 |
| 15 | 371.591 | 372.5136 | 99.75 |
| 16 | 371.7511 | 372.4853 | 99.80 |
| 17 | 370.6496 | 371.8734 | 99.67 |
| 18 | 371.1015 | 372.0241 | 99.75 |
| 19 | 370.0848 | 370.8568 | 99.79 |
| 20 | 370.0377 | 370.6308 | 99.84 |
| 21 | 366.1969 | 367.2983 | 99.70 |
| 22 | 367.9102 | 370.9415 | 99.18 |
| 23 | 364.1259 | 365.3873 | 99.65 |
| 24 | 361.7724 | 362.7891 | 99.72 |
| 25 | 362.8268 | 363.3257 | 99.86 |
| 26 | 361.5936 | 362.4408 | 99.77 |
| 27 | 362.7797 | 363.8905 | 99.69 |
| 28 | 364.2765 | 364.7378 | 99.87 |
| 29 | 361.8477 | 362.4314 | 99.84 |
| 30 | 360.671 | 361.4429 | 99.79 |
| 31 | 357.4233 | 358.214 | 99.78 |
| 32 | 356.8961 | 357.4044 | 99.86 |

It is obvious that the foregoing embodiments of the invention are examples and can be varied in many ways. Such present or future variations are not to be regarded as a departure from the spirit and scope of the invention, and all such modifications as would be obvious to one skilled in the art are intended to be included within the scope of the following claims.

We claim:

1. A process for preparing spheroidal additive-enhanced graphite particles comprising the steps of:
providing a premixed composite of a flake graphitic component and an additive nanoparticle component;
subjecting the composite to a spheroidization process to provide the spheroidal additive-enhanced graphite particles; and
applying a carbon coating to the spheroidal additive-enhanced graphite particles,
wherein the additive nanoparticles component comprises silicon nanoparticles having the primary particle size range from 20 to 100 nanometers,
wherein the silicon nanoparticles are monocrystalline silicon nanoparticles,
wherein the composite comprises from about 2.25 to about 9.0 wt. % of silicon nanoparticles, and
wherein the graphitic component comprises high purity natural crystalline flake graphite comprising at least about 99.5 wt. % carbon.

2. The process of claim 1, wherein the additive nanoparticle component further comprises synthetic graphite, boron, germanium, tin, lead, aluminum, bismuth, magnesium, sulfur, or any combination thereof.

3. The process of claim 1, wherein the composite comprises about 2.25 to about 4.5 wt. % of silicon nanoparticles.

4. The process of claim 1, wherein the silicon nanoparticles are produced by plasma pyrolysis of silicon dust to form the monocrystalline silicon.

5. The process of claim 1, wherein the additive nanoparticle component further comprises synthetic graphite.

6. The process of claim 5, wherein the composite comprises from about 0.5 wt. % to about 30 wt. % of synthetic graphite, or from about 0.5 wt. % to about 5 wt. % of synthetic graphite, or about 15 wt. % to about 28 wt. % of synthetic graphite.

7. (canceled)

8. (canceled)

9. The process claim 1, wherein the additive nanoparticle component further comprises boron, tin or sulfur.

10. (canceled)

11. (canceled)

12. The process of claim 1, wherein the additive nanoparticle component is added on a continuous basis throughout the spheroidization process.

13. The process of claim 1, wherein the flake graphite has undergone one or more of a pre-sizing step and a purification step prior to mixing with the silicon nanoparticles, wherein the pre-sizing step is optionally carried out by air milling, mechanical milling or wet attrition milling, and the purification step is optionally carried out by a thermal pre-treatment step, a wet chemical pre-treatment step, or a combination thereof.

14. (canceled)

15. The process of claim 1, wherein the composite further comprises an expanded graphite produced by an expansion step carried out by intercalating a graphitic precursor with an acid or acid mixture and heating the intercalated graphitic precursor to provide the expanded graphite.

16. (canceled)

17. The process of claim 1, wherein the graphitic component has a purity of at least 99.95 wt. %.

18. The process of claim 1, wherein the spheroidization process is carried out in a spheroidizing mill, a roller mill, a hammer mill, a pulverizing mill, or a hybridizer mill.

19. The process of claim 1, wherein the composite comprises flake graphite having a maximum particle size of about 270 mesh.

20. The process of claim 1, wherein the composite further comprises boron.

21. The process of claim 20, wherein the composite comprises from about 0.5 wt. % to about 5 wt. % boron.

22. Spheroidal additive-enhanced graphite particles prepared using the process as defined in claim 1.

23. An anode material comprising:
from about 85 wt. % to about 90 wt. % of spheroidal additive-enhanced graphite particles as defined in claim 22,
from about 8 wt. % to about 12 wt. % of a binder component, and
from about 0.5 wt. % to about 5 wt. % of an amorphous carbon component.

24. The anode material of claim 23, comprising about 87 wt. % of the additive-enhanced graphite particles, about 9.5 wt. % of the binder component, and about 3.5 wt. % of the amorphous carbon component.

25. A lithium ion rechargeable battery cell comprising: an anode material as defined in claim 23 or 24, an organic solvent electrolyte, a lithium-rich counter electrode, a separator, and a stainless steel cell housing in which the positive and the negative terminals are separated by a polymer spacer.

26. The lithium ion battery cell of claim 25, wherein the additive is silicon and wherein the silicon content of the anode material is determined by the method of Loss on Ignition prior to cell assembly to ensure accurate cell components balancing.
